(19) United States
(12) Patent Application Publication
(10) Pub. No.: US 2025/0076549 A1
(43) Pub. Date: Mar. 6, 2025

(54) OPTICAL COMMUNICATION OPTICAL SYSTEM AND OPTICAL COMMUNICATION APPARATUS

(71) Applicant: Tamron Co., Ltd., Saitama (JP)

(72) Inventor: Shingo FUSE, Saitama (JP)

(73) Assignee: Tamron Co., Ltd., Saitama (JP)

(21) Appl. No.: 18/731,800

(22) Filed: Jun. 3, 2024

(30) Foreign Application Priority Data
Aug. 28, 2023 (JP) 2023-137963

(51) Int. Cl. G02B 5/04; G02B 6/27; G02B 27/28

(52) U.S. Cl. CPC G02B 5/045; G02B 6/27; G02B 27/283

(57) ABSTRACT

An optical communication optical system includes four groups of a first group to a fourth group. The optical communication optical system satisfies a first relationship based on focal lengths of the first group and the second group, and a second relationship based on a rotation angle and an apex angle of two wedge prisms in which the third group rotates in opposite directions at the same angle in each of two wedge prism pairs.

### CROSS-REFERENCE TO RELATED APPLICATIONS

This application is based on and claims the benefit of priority from Japanese Patent Application No. 2023-137963, filed on Aug. 28, 2023, the entire contents of which are incorporated herein by reference.

### BACKGROUND OF THE INVENTION

### Technical Field

The present invention relates to an optical communication optical system and an optical communication apparatus.

### Related Art

In recent years, communication technologies based on radio waves such as 5G have been dramatically sped up. In the field of communication technology, it is required to cope with such an increase in speed. Optical wireless communication (also referred to as “optical communication”) is currently attracting attention as high-speed communication. Optical wireless communication is particularly suited for communication between fixed sites, for example, base stations and relay points. In such an optical communication technology, a beam expander that enlarges a beam diameter of parallel light (collimated light) while maintaining the parallel light by an optical system having a short lens total length is known (for example, see JP H04-362608 A).

On the other hand, in optical wireless communication, a vibration isolation technology for preventing vibration of an optical communication apparatus itself in which an optical communication optical system is installed is required. In the technology described in JP H04-362608 A, there is room for examination from the viewpoint of vibration isolation of the optical communication apparatus.

As a vibration isolation technology in optical wireless communication, a technology of installing an optical system on a mount such as a gimbal mechanism is generally known. However, even minute vibration may not be sufficiently prevented by a gimbal mechanism or the like. As a result, communication failure may occur in reception of optical wireless communication due to optical axis deviation during communication due to the vibration.

In addition, as a vibration isolation technology in optical wireless communication, a technology using a fine pointing mirror by MEMS (microelectromechanical system) driving is generally known. However, since the price of the fine pointing mirror is expensive and the size is small, it is very difficult to arrange the fine pointing mirror according to the size of the beam diameter, and there is room for consideration.

As an optical wireless communication technology that solves the above-described problems such as vibration isolation, size, and cost, an image shake correction device capable of performing image shake correction by an optical path deflection action by a wedge prism and suppressing an increase in optical path length and an increase in cost is known (for example, see JP 2008-209712 A).

However, in the technology described in JP 2008-209712 A, a convex lens or a concave lens is attached to one wedge prism. Therefore, since the weight of the wedge prism increases, it is disadvantageous for the rotation control of the wedge prism. In addition, since the lens is attached to the wedge prism, an arrangement place of the wedge prism in the optical system is limited. Furthermore, since the lens is attached to the wedge prism, the eccentricity of the lens itself is added in the rotation control of the wedge prism, and the correction (rotation angle for correcting the incident angle) of the wedge prism at the time of vibration isolation correction becomes large. As a result, the control becomes difficult.

An object of an aspect of the present invention is to realize a technology capable of easily preventing vibration of signal light in an optical communication optical system including a wedge prism.

### SUMMARY OF THE INVENTION

In order to solve the above-described problems, an optical communication optical system according to an aspect of the present invention is an optical communication optical system disposed on an optical path of signal light emitted from a light emitting element and transmitted or signal light incident on a light receiving element and received, the optical communication optical system comprising:
a first group, a second group, a third group, and a fourth group arranged in this order from a side opposite to the light emitting element or the light receiving element,
wherein the first group changes a beam diameter of the signal light so as to be smaller at an end on the second group side in an optical axis direction,
wherein the second group changes a beam diameter of the signal light so as to be smaller at an end on the third group side in the optical axis direction,
wherein the third group includes two wedge prism pairs, and the wedge prism pairs include two wedge prisms that rotate in opposite directions and at the same rotation angle,
wherein the fourth group changes a beam diameter of the signal so as to be smaller at an end on the light emitting element side or the light receiving element side in the optical axis direction, and
wherein Formulae (1) and (2) below are satisfied.

$$3.89 < Ff / Bf < 14. \qquad ( 1 )$$

$$0.09 < R / a < 6.565 \qquad ( 2 )$$

(in Formula (1), Ff represents a focal length (mm) of the first group, Bf represents a focal length (mm) of the second group, and in Formula (2), R represents a rotation angle of the wedge prism in one or the other wedge prism pair, and a represents an apex angle of the wedge prism in one or the other wedge prism pair).

In order to solve the above-described problems, an optical communication apparatus according to an aspect of the present invention includes the above optical communication optical system.

According to an aspect of the present invention, it is possible to easily prevent the vibration of the signal light in the optical communication optical system including the wedge prism.

### BRIEF DESCRIPTION OF THE DRAWINGS

FIG. 1 is a diagram schematically illustrating a configuration of an optical communication apparatus according to an embodiment of the present invention;

FIG. 2 is a perspective view schematically illustrating arrangement of wedge prisms in a third group according to an embodiment of the present invention;

FIG. 3 is a front view schematically illustrating arrangement of wedge prisms in a third group according to an embodiment of the present invention;

FIG. 4 is a plan view schematically illustrating arrangement of wedge prisms in a third group according to an embodiment of the present invention;

FIG. 5 is a view schematically illustrating a drive mechanism of a wedge prism pair according to an embodiment of the present invention;

FIG. 6 is a front view schematically illustrating a configuration of an optical communication optical system of Example 1;

FIG. 7 is a spherical aberration diagram of light having a wavelength of 1550 nm of an optical system obtained by removing the wedge prism from the optical communication optical system of Example 1;

FIG. 8 is a diagram illustrating wavelength dependency of a focus shift amount at wavelengths of 1530 nm to 1565 nm of the optical communication optical system of Example 1;

FIG. 9 is a front view schematically illustrating a configuration of an optical communication optical system according to Example 2;

FIG. 10 is a spherical aberration diagram of light having a wavelength of 1550 nm of an optical system obtained by removing the wedge prism from the optical communication optical system of Example 2;

FIG. 11 is a diagram illustrating wavelength dependency of a focus shift amount at wavelengths of 1530 nm to 1565 nm of the optical communication optical system of Example 2;

FIG. 12 is a front view schematically illustrating a configuration of an optical communication optical system of Example 3;

FIG. 13 is a spherical aberration diagram of light having a wavelength of 1550 nm of an optical system obtained by removing the wedge prism from the optical communication optical system of Example 3;

FIG. 14 is a diagram illustrating wavelength dependency of a focus shift amount at wavelengths of 1530 nm to 1565 nm of the optical communication optical system of Example 3;

FIG. 15 is a front view schematically illustrating a configuration of an optical communication optical system of Example 4;

FIG. 16 is a spherical aberration diagram of light having a wavelength of 1550 nm of an optical system obtained by removing the wedge prism from the optical communication optical system of Example 4;

FIG. 17 is a diagram illustrating wavelength dependency of a focus shift amount at wavelengths of 1530 nm to 1565 nm of the optical communication optical system of Example 4;

FIG. 18 is a front view schematically illustrating a configuration of an optical communication optical system of Example 5;

FIG. 19 is a spherical aberration diagram of light having a wavelength of 1550 nm of an optical system obtained by removing the wedge prism from the optical communication optical system of Example 5;

FIG. 20 is a diagram illustrating wavelength dependency of a focus shift amount at wavelengths of 1530 nm to 1565 nm of the optical communication optical system of Example 5;

FIG. 21 is a front view schematically illustrating a configuration of an optical communication optical system of Example 6;

FIG. 22 is a spherical aberration diagram of light having a wavelength of 1550 nm of an optical system obtained by removing the wedge prism from the optical communication optical system of Example 6;

FIG. 23 is a diagram illustrating wavelength dependency of a focus shift amount at wavelengths of 1530 nm to 1565 nm of an optical communication optical system of Example 6;

FIG. 24 is a front view schematically illustrating a configuration of an optical communication optical system of Example 7;

FIG. 25 is a spherical aberration diagram of light having a wavelength of 1550 nm of an optical system obtained by removing the wedge prism from the optical communication optical system of Example 7;

FIG. 26 is a diagram illustrating wavelength dependency of a focus shift amount at wavelengths of 1530 nm to 1565 nm of the optical communication optical system of Example 7;

FIG. 27 is a front view schematically illustrating a configuration of an optical communication optical system of Example 8;

FIG. 28 is a spherical aberration diagram of light having a wavelength of 1550 nm of an optical system obtained by removing the wedge prism from the optical communication optical system of Example 8;

FIG. 29 is a diagram illustrating wavelength dependency of a focus shift amount at wavelengths of 1530 nm to 1565 nm of the optical communication optical system of Example 8;

FIG. 30 is a front view schematically illustrating a configuration of an optical communication optical system of Example 9;

FIG. 31 is a spherical aberration diagram of light having a wavelength of 1550 nm of an optical system obtained by removing the wedge prism from the optical communication optical system of Example 9;

FIG. 32 is a diagram illustrating wavelength dependency of a focus shift amount at wavelengths of 1530 nm to 1565 nm of the optical communication optical system of Example 9;

FIG. 33 is a front view schematically illustrating a configuration of an optical communication optical system of Example 10;

FIG. 34 is a spherical aberration diagram of light having a wavelength of 1550 nm of an optical system obtained by removing the wedge prism from the optical communication optical system of Example 10;

FIG. 35 is a diagram illustrating wavelength dependency of a focus shift amount at wavelengths of 1530 nm to 1565 nm of the optical communication optical system of Example 10;

FIG. 36 is a front view schematically illustrating a configuration of an optical communication optical system of Example 11;

FIG. 37 is a spherical aberration diagram of light having a wavelength of 1550 nm of an optical system obtained by removing the wedge prism from the optical communication optical system of Example 11;

FIG. 38 is a diagram illustrating wavelength dependency of a focus shift amount at wavelengths of 1530 nm to 1565 nm of the optical communication optical system of Example 11;

FIG. 39 is a front view schematically illustrating a configuration of an optical communication optical system of Example 12;

FIG. 40 is a spherical aberration diagram of light having a wavelength of 1550 nm of an optical system obtained by removing the wedge prism from the optical communication optical system of Example 12; and

FIG. 41 is a diagram illustrating wavelength dependency of a focus shift amount at wavelengths of 1530 nm to 1565 nm of the optical communication optical system of Example 12.

### DESCRIPTION OF THE EMBODIMENTS

Hereinafter, an embodiment of the present invention will be described in detail. The present embodiment is an optical communication optical system that transmits or receives signal light for use in optical communication, and has a function of correcting an optical core due to angular variation of signal light generated by vibration or the like of an optical communication apparatus equipped with the optical system with a cheaper configuration.

### Optical Communication Optical System

### Optical Configuration

An optical communication optical system according to an embodiment of the present invention is disposed on an optical path of signal light emitted from a light emitting element and transmitted or signal light incident on a light receiving element and received. In this way, the optical communication optical system of the present embodiment is arranged in combination with the light emitting element that emits the signal light passing through the optical system or the light receiving element on which the signal light passing through the optical system is incident.

The optical communication optical system of the present embodiment includes a first group, a second group, a third group, and a fourth group arranged in this order from a side opposite to the light emitting element or the light receiving element. Each group is fixed at a specific position in the optical axis direction determined from the viewpoint of exhibiting a desired function. Each group may be fixed so as to be appropriately positionable in the optical axis direction from the viewpoint of versatility and the like.

The first group, the second group, and the fourth group are groups of optical elements including lenses. Examples of lenses include single lenses, cemented lenses, and compound lenses. Examples of single lenses include spherical and aspherical lenses. It is preferable that at least one of the first group, the second group, and the fourth group includes an aspherical lens from the viewpoint of suppressing the aberration in the optical communication optical system and improving the condensing performance of the entire optical system to suppress the change in the beam diameter and the spot shape at the time of vibration isolation. The effect by including the aspherical lens tends to be more remarkable as the lens diameter is larger. From such a viewpoint, it is more preferable that the first group or the second group includes an aspherical lens, and it is still more preferable that the first group includes an aspherical lens.

The third group includes a wedge prism pair. The optical configuration of the third group will be described in detail later.

The first group to the fourth group may further include an optical element other than the lens or the wedge prism as long as the effect of the present embodiment can be obtained. Examples of the other optical element include a parallel flat plate, a mirror, a filter, and a beam splitter.

### First Group

The first group is designed to change the beam diameter of the signal light so as to be smaller at the end on the second group side in the optical axis direction. When a direction from the fourth group toward the first group in the optical axis direction of the optical communication optical system is an outward direction, and a direction from the first group toward the fourth group is an inward direction, signal light outside the first group is signal light propagating between optical communication apparatuses in optical communication, and is, for example, collimated light having a larger beam diameter. The signal light inside the first group may be collimated light having a smaller beam diameter, converging light having a beam diameter gradually reduced, or converging and diverging light having a beam diameter gradually reduced and concentrated and then spreading.

### Second Group

The second group is designed to change the beam diameter of the signal light so as to be smaller at the end on the third group side in the optical axis direction. The signal light inside the second group may be collimated light having a smaller beam diameter, converging light, or converging and diverging light. From the viewpoint of maintaining a constant cross-sectional shape (also referred to as a “spot shape”) of the beam of the signal light at the time of passing through the wedge prism in the third group and suppressing a decrease in communication performance due to a change in the spot shape of the signal light, the signal light inside the second group is preferably collimated light.

In optical communication, signal light propagating between optical communication apparatuses is usually collimated light. From such a viewpoint, it can be said that the first group is a lens group that transmits collimated light having the maximum beam diameter among the collimated light in the optical communication apparatus to the outside or receives the collimated light from the outside. In addition, from the viewpoint of the accuracy of optical communication as described above, the signal light propagating between the second group and the third group is preferably collimated light. From such a viewpoint, it can be said that the second group is a lens group that transmits collimated light having a minimum beam diameter among the collimated light in the optical communication apparatus to the inside or receives the collimated light from the inside. Thus, the first group and the second group can function as beam expanders that increase the beam diameter of the collimated light from the inside to the outside. In this way, the first group and the second group may be lens groups that together function as the beam expander.

In the beam expander optical system having the second group that is sufficiently separated from the first group that forms the maximum collimated light and forms the minimum collimated light, when the optical system is of a Galilean in which converging light is incident on the second group from the first group and minimum collimated light is generated in the second group, it is preferable from the viewpoint of further reducing the number of lenses and further simplifying the optical configurations of the first group and the second group (for reducing the beam diameter of the collimated light). When the optical system is of a Keplerian in which converging light from the first group forms a primary image between the first group and the second group that forms the maximum collimated light, diverges again, enters the second group, and becomes the minimum collimated light in the second group, it is preferable from the viewpoint of suppressing occurrence of aberration. Furthermore, the sufficient distance between the first group and the second group is preferably the maximum interval among the intervals between the lenses arranged between the object side of the first group and the image side of the second group from the viewpoint of facilitating control of the ratio between the maximum collimating diameter for forming the first group and the minimum collimating diameter of the second group and from the viewpoint of reducing the aberration generated by the ratio by the diameter.

### Third Group

The third group includes two wedge prism pairs. Each wedge prism pair includes two wedge prisms that rotate in opposite directions and at the same rotation angle.

In each wedge prism pair, the two wedge prisms are arranged such that one inclined surface and the other inclined surface face each other in a non-contact manner, and one vertex angle and the other vertex angle are located on opposite sides to each other across the optical axis. The positions of the wedge prisms when the long axes on the inclined surfaces of the wedge prisms in the wedge prism pair overlap each other in the optical axis direction are defined as positions where the wedge prisms face each other, and these positions are also referred to as reference positions.

In the third group, when all the wedge prisms are at the reference position, the two wedge prism pairs are arranged such that the long axis in one wedge prism pair and the long axis in the other wedge prism pair intersect each other, preferably orthogonally, when viewed along the optical axis direction. With this arrangement, it is possible to eliminate the vibration of the signal light in the plane direction orthogonal to the optical axis. It is preferable that the long axes of the two wedge prism pairs are arranged to be orthogonal to each other from the viewpoint of minimizing the rotation angle of each wedge prism in vibration isolation and improving the accuracy and performance of vibration isolation with respect to the vibration of the signal light. For example, each of the two wedge prism pairs performs vibration isolation correction in the X direction and the Y direction.

As the apex angle of the wedge prism is larger, the sensitivity of deflection of the signal light becomes higher, and the rotational movement of the wedge prism is required to be controlled with higher accuracy. The apex angle of the wedge prism may be appropriately determined from the viewpoint of fineness of vibration of the signal light and accuracy of the control.

As the drive device that rotationally moves the wedge prism, it is possible to adopt a known drive device in a range in which the wedge prism can be rotated so as to cope with fine vibration isolation of the signal light. A voice coil motor can be suitably adopted as the drive device from the viewpoint of realizing high-speed rotational drive and control of the rotation angle.

### Fourth Group

The fourth group is designed to change the beam diameter of the signal light so as to be smaller at the end on the light emitting element or the light receiving element side in the optical axis direction. The signal light on the outer side (third group side) of the fourth group may be collimated light having a larger beam diameter, diffused light having a beam diameter increasing outward, or converging and diverging light. Similarly to the second group, from the viewpoint of maintaining the cross-sectional shape of the beam of the signal light at the time of passing through the wedge prism in the third group constant and suppressing the deterioration of the communication performance due to the change in the cross-sectional shape, the signal light outside the fourth group is preferably collimated light.

The signal light inside the fourth group may be collimated light having a smaller beam diameter, converging light, or converging and diverging light according to the inside configuration. For example, when the light emitting element or the light receiving element is directly disposed inside the fourth group, or when the fourth group and the light emitting element are optically connected via an optical fiber, the signal light may be any of the above. When the fourth group and the light receiving element are optically connected via an optical fiber, the signal light may be converging light. From the viewpoint of versatility applicable to both the transmission device and the reception device of the optical communication apparatus, it is preferable that the fourth group is designed such that the inner signal light becomes converging light.

### Other Configurations

The optical communication optical system of the present embodiment may further include a configuration other than the first to fourth groups described above as long as the effects of the present embodiment can be obtained. Examples of other configurations include a position adjustment device. The position adjustment device can include a detection unit that detects a difference between an actual position of the signal light and a reference position thereof, and a control unit that controls the rotation of the wedge prism such that the difference detected by the detection unit becomes small. The reference position of the signal light is, for example, the position of the signal light when the center of the shape of the signal light (also called “spot shape”, usually circular) in a plane perpendicular to the optical axis of the signal light is the optical axis. The signal light detected by the position adjustment device is preferably signal light that is collimated light from the viewpoint of improving the detection accuracy of the position of the signal light with respect to the optical axis, and is preferably signal light having a smaller beam diameter from that viewpoint. From such a viewpoint, the signal light detected by the position adjustment device is preferably signal light between the second group and the third group or between the third group and the fourth group.

### Beam Diameter

The smaller the beam diameter of the signal light in the optical communication optical system of the present embodiment, the higher the power density of the signal light and the higher the sensitivity of deflection of the signal light by the wedge prism. The beam diameter of the signal light between the second group and the fourth group in the optical communication optical system may be appropriately determined from the viewpoint of the power density and the sensitivity.

### Condition Expressing Formula

The optical communication optical system of the present embodiment preferably adopts the above-described configuration and satisfies at least one or more of the following formulae.

$$< Formula ( 1 ) >$$

$$3.89 < Ff / Bf < 14. \qquad ( 1 )$$

Here, “Ff” represents the focal length (mm) of the first group, and “Bf” represents the focal length (mm) of the second group. The “focal length of the first group” is the focal length of the lens group that forms the maximum collimated light, and the “focal length of the second group” is the focal length of the lens group that forms the minimum collimated light. In the present embodiment, Formula (1) is satisfied even when the first group and the second group constitute either a Galilean or a Keplerian optical system.

When Ff/Bf is less than the lower limit of Formula (1), the rotation angle of the wedge prism at the time of vibration isolation correction becomes too small, and the resolution of the rotation angle is increased, so that the rotation stop accuracy at the time of correction may be insufficient. When Ff/Bf exceeds the upper limit of Formula (1), the rotation angle of the wedge prism at the time of vibration isolation correction becomes too large, the rotation at the time of vibration isolation correction becomes slow, and it may take time to perform correction. From the viewpoint of obtaining appropriate rotational resolution, Ff/Bf is more preferably 5.2 or more, still more preferably 6.5 or more. In addition, Ff/Bf is more preferably 7.8 or less, still more preferably 6.5 or less from the viewpoint of defining an appropriate correction time at the time of correcting the vibration isolation angle.

$$< Formula ( 2 ) >$$

$$0.09 < R / a < 6.565 \qquad ( 2 )$$

Here, “R” represents the rotation angle of the wedge prism in one or the other wedge prism pair, and “a” represents the apex angle of the wedge prism in one or the other wedge prism pair. As described above, R and a in Formula (2) define the relationship between the rotation angle and the vertical angle of the wedge prism in each wedge prism pair.

When the rotation angle of the wedge prism in one wedge prism pair of the third group of two wedge prism pairs is R1 and the apex angle is a1, and the rotation angle of the wedge prism in the other wedge prism pair is R2 and the apex angle is a2, Formula (2) is expressed by Formulae (2-1) and (2-2) below. In the following description, R is a generic term for R1 and R2, and represents one or both of R1 and R2. Similarly, a is a generic term for a1 and a2, and represents one or both of them.

$$0.09 < R 1 / a 1 < 6.565 \qquad ( 2 - 1 )$$

$$0.09 < R 2 / a 2 < 6.565 \qquad ( 2 - 2 )$$

When R/a is less than the lower limit of Formula (2), the apex angle of the wedge prism becomes large, and the spot shape of the signal light becomes elliptical and may become large. In addition, when R/a is less than the lower limit of Formula (2), the rotation angle of the wedge prism becomes small, the resolution of the rotation of the wedge prism decreases, and the accuracy of vibration isolation of the signal light may decrease. When R/a exceeds the upper limit of Formula (2), the rotation angle of the wedge prism becomes large, the rotation speed of the wedge prism becomes slow, and the fast vibration of the signal light cannot be tracked in some cases. From the viewpoint of improving the accuracy of signal light vibration isolation, R/a is more preferably 0.129 or more, still more preferably 0.72 or more. In addition, R/a is more preferably 1.046 or less, still more preferably 1.57 or less from the viewpoint of improving the accuracy of signal light vibration isolation.

$$< Formula ( 3 ) >$$

$$\vert C 1 - C 2 \vert \leq 14.715 \qquad ( 3 )$$

Here, “C1” represents the movement amount (μm) of the focal position of the signal light having the wavelength of 1530 nm with reference to the focal position of the signal light having the wavelength of 1550 nm, and “C2” represents the movement amount (μm) of the focal position of the signal light having the wavelength of 1565 nm with reference to the focal position of the signal light having the wavelength of 1550 nm.

Formula (3) defines axial chromatic aberration of the optical communication optical system. More specifically, Formula (3) defines the difference in the size of the spot shape of the signal light due to the chromatic aberration at the time of switching to any wavelength of the C-band in optical communication.

When |C1-C2| is larger than 14.715, the focal point of the signal light of another wavelength in the C band region with respect to the signal light of a wavelength of 1550 nm deviates, the spot diameter of the signal light increases, and the communication performance in optical communication may deteriorate. From the viewpoint of improving communication performance, |C1-C2| is more preferably 2.0 or less. |C1-C2| may be smaller from the viewpoint of communication performance, and may be 0 or more.

$$< Formula ( 4 ) >$$

$$1.4 < n < 1.674 \qquad ( 4 )$$

Here, “n” represents a refractive index of light having a wavelength of 1550 nm in the material of the wedge prism. “n” may be the same for any wedge prism, may be different for each wedge prism pair, or may be different for each wedge prism. Formula (4) defines the glass material of the wedge prism.

When n is 1.674 or less, the rotation angle of the wedge prism decreases, the resolution of the rotation of the wedge prism decreases, and the accuracy of signal light vibration isolation may decrease. From the viewpoint of improving the accuracy of signal light vibration isolation, n is more preferably 1.5 or less, still more preferably 1.46 or less. n may be 1.5 or more or 1.6 or more from the viewpoint of the optical axis deviation at the time of vibration isolation correction. The most preferable range is 1.4 or more and 1.45 or less.

### Optical Communication Apparatus

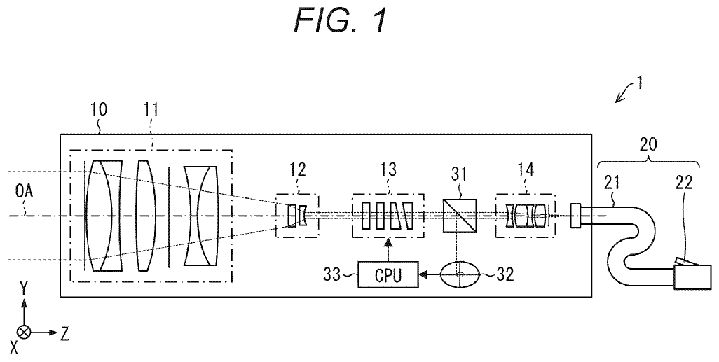

Next, an optical communication apparatus according to an embodiment of the present invention will be described. FIG. 1 is a diagram schematically illustrating a configuration of an optical communication apparatus according to an embodiment of the present invention. As illustrated in FIG. 1, the optical communication apparatus 1 includes a casing 10 and an optical fiber 20. The casing 10 is an elongated rectangular casing, has an opening through which signal light passes at one end, and has an optical fiber 20 inserted at the other end. In the drawing, the Z direction is a direction along the optical axis OA. The side indicated by the arrow of the Z axis is the inner side described above, and the opposite side is the outer side. The Y direction and the X direction are directions orthogonal to each other and orthogonal to the Z direction.

The optical fiber 20 includes a single mode fiber 21 and a connector 22. The connector 22 is optically connected to a light emitting element that emits signal light or a light receiving element on which signal light is incident. The light emitting element may be an element that converts electricity into light, and is, for example, a light emitting diode or a semiconductor laser. The light receiving element may be an element that receives signal light in optical communication and converts the signal light into an electrical signal, and is, for example, a photodiode or a complementary metal oxide semiconductor (CMOS) image sensor. The connector 22 may be connected to a further optical fiber.

The optical communication optical system is disposed in the casing 10. The optical communication optical system includes a first group 11, a second group 12, a third group 13, and a fourth group 14. These are arranged in the order described above in order from the side opposite to the optical fiber 20 connected to the light emitting element or the light receiving element. In addition, the optical communication optical system further includes a beam splitter 31 that splits a part of the signal light from the third group 13 in the optical path of the signal light between the third group 13 and the fourth group 14, and a split photodiode 32 into which the signal light split from the beam splitter 31 is incident. The split photodiode 32 includes four detection units divided into four by an X axis corresponding to the X direction and a Y axis corresponding to the Y direction, and each of the intensities Q1 to Q4 detected by each detection unit is input to a control unit 33.

When the light emitting element is connected to the optical fiber 20, the signal light passing through the group is also referred to as “transmission light”, and when the light receiving element is connected to the optical fiber 20, the signal light passing through the group is also referred to as “reception light”. The “signal light” is a generic term for transmission light and reception light, and means one or both of them.

In the present embodiment, the first group 11 transmits or receives collimated light from the end on the opening side of the casing 10, and transmits or receives signal light in which the beam diameter gradually decreases toward the second group 12 from the end on the side of the second group 12. The second group 12 transmits or receives signal light in which a beam diameter gradually decreases toward the second group 12 at an end on the side of the first group 11, and transmits or receives signal light that is collimated light toward the third group 13 at an end on the side of the third group 13. The fourth group 14 transmits or receives signal light that is collimated light at an end on the side of the third group 13, and transmits or receives signal light whose beam diameter gradually decreases toward the core of the optical fiber 20 at an end on the side of the optical fiber 20.

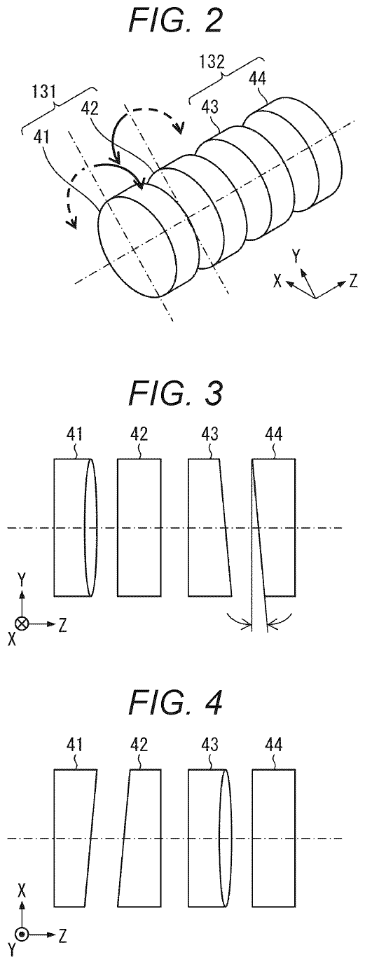

FIG. 2 is a perspective view schematically illustrating the arrangement of the wedge prisms in the third group in the present embodiment. As illustrated in FIG. 2, the third group 13 includes two wedge prism pairs 131 and 132. In the present embodiment, the wedge prism pair 131 is arranged on the side of the second group 12, and the wedge prism pair 132 is arranged on the fourth group side.

Each wedge prism pair includes two wedge prisms. FIG. 3 is a front view schematically illustrating the arrangement of the wedge prisms in the third group in the present embodiment, and FIG. 4 is a plan view schematically illustrating the arrangement of the wedge prisms in the third group in the present embodiment. As illustrated in FIGS. 3 and 4, the wedge prism pair 131 includes two wedge prisms 41 and 42, and the wedge prism pair 132 includes two wedge prisms 43 and 44.

As illustrated in FIG. 3, the wedge prism (for example, reference numeral 44) has a shape in which one end face of a cylinder is formed obliquely, and one end face is arranged perpendicular to the optical axis and the other end face is arranged obliquely (at an angle with respect to a plane perpendicular to the optical axis). An angle formed by the other end face with respect to a plane perpendicular to the optical axis (an angle indicated by a curved arrow in FIG. 3) is a vertical angle of the wedge prism.

The rotation of the wedge prisms in the wedge prism pair is reversed when one of the wedge prisms rotates forward. For example, in the case of the wedge prism pair 131, the wedge prism 41 rotates counterclockwise when the wedge prism 42 rotates clockwise as indicated by a solid curved arrow in FIG. 2, and the wedge prism 41 rotates clockwise when the wedge prism 42 rotates counterclockwise as indicated by a broken curved arrow.

In the arrangement in the initial state, the apex angle of the wedge prism 41 is located on one side on the X axis, and the apex angle of the wedge prism 42 is located on the other side on the X axis. In the arrangement in the initial state, the apex angle of the wedge prism 43 is located on one side on the Y axis, and the apex angle of the wedge prism 44 is located on the other side on the Y axis. As described above, when the line connecting the apex angle and the center of the wedge prism is defined as the axis of the wedge prism, in each wedge prism, the two wedge prisms are installed such that the axes overlap and the apex angle is at the target position with respect to the center when viewed along the direction of the optical axis OA. Each wedge prism pair is disposed such that the axis of the wedge prism in one wedge prism pair is orthogonal to the axis of the wedge prism in the other wedge prism pair.

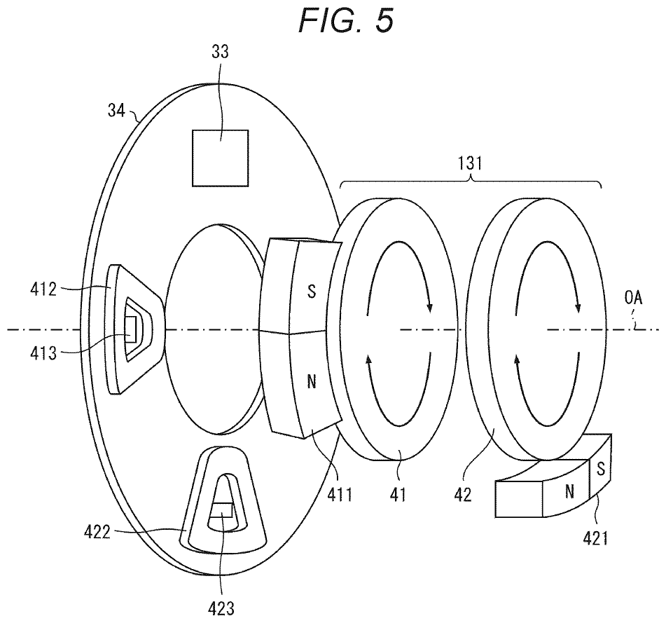

Each wedge prism pair includes two wedge prisms that rotate in opposite directions and at the same rotation angle. FIG. 5 is a view schematically illustrating a drive mechanism of a wedge prism pair in the present embodiment. FIG. 5 illustrates that of the wedge prism pair 131, but the wedge prism pair 132 has a similar configuration.

As illustrated in FIG. 5, the drive mechanism includes a first coil 412 disposed on an annular substrate 34, a first Hall element 413 disposed inside the first coil 412, a second coil 422, and a second hall element 423 disposed inside the second coil 422. The first coil 412 and the second coil 422 are disposed at four-fold rotational symmetry positions (positions shifted by) 90° in plan view, and each coil is formed of a conductive wire wound in a substantially fan shape in plan view.

In addition, the drive mechanism includes a first magnet 411 disposed at a position corresponding to the first coil 412 in plan view and corresponding to the wedge prism 41 (for example, in a frame of the wedge prism 41), and a second magnet 421 disposed at a position corresponding to the second coil 422 in plan view and corresponding to the wedge prism 42 (for example, in a frame of the wedge prism 42). Furthermore, the control unit 33 described above is also disposed on the substrate 34.

The coil and the magnet constitute a voice coil motor that rotates the wedge prism by energizing the coil. When the first coil 412 is energized, the wedge prism 41 rotates, for example, in a clockwise direction, and when the second coil 422 is energized, the wedge prism 42 rotates, for example, in a counterclockwise direction. The first coil 412 and the second coil 422 are supplied with substantially the same amount of current at substantially the same time, and the wedge prism 41 and the wedge prism 42 rotate in opposite directions at substantially the same rotation angle.

Hereinafter, the rotational movement of the wedge prism will be specifically described using the wedge prism 41 as an example. In the present embodiment, the other wedge prisms also rotationally move similarly to the wedge prism 41, but the description of the rotational movement of the other wedge prisms will not be repeated.

When the first coil 412 is energized, the first Hall element 413 detects a voltage corresponding to a magnetic field (magnetic flux density). The rotation angle of the wedge prism 41 can be approximated to a voltage value (magnetic flux density) detected by the first Hall element 413 in a specific range by a linear expression. The control unit 33 acquires the current rotation angle of the wedge prism 41 on the basis of such a correlation. The control unit 33 controls the rotation of the wedge prism 41 by the voice coil motor according to the acquired current angle, and rotates the wedge prism 41 so as to have a target rotation angle.

The target rotation angle can be obtained, for example, as follows. The control unit 33 acquires output values Q1 to Q4 of the split photodiode 32. In addition, the control unit 33 acquires displacement amounts in the X-axis direction and the Y-axis direction in the signal light according to the acquired output values Q1 to Q4. For example, displacement amount Δx in the X-axis direction and displacement amount Δy in the Y-axis direction are obtained from the following formulae.

$$Δ x = ( Q 1 + Q 3 ) - ( Q 2 + Q 4 )$$

$$Δ y = ( Q 1 + Q 2 ) - ( Q 3 + Q 4 )$$

Next, the control unit 33 acquires, for example, the rotation angle θx of the wedge prisms 41 and 42 corresponding to the X axis and the rotation angle θy of the wedge prisms 43 and 44 corresponding to the Y axis from Δx and Δy in the split photodiode 32 on the basis of the correlation between the position of the signal light in a light receiving unit 200 and the position of the split light in the split photodiode 32. θx is a difference between Ax, which is the rotation angle (for example, 0°, initial position or reference position) of the wedge prisms 41 and 42 when the reception position of the signal light is the center position of the split photodiode 32, and Bx, which is the correction rotation angle for correcting blurring of the signal light, for example, a target value in PID control. θy is a difference between Ay, which is the rotation angle (for example, 0°) of the wedge prisms 43 and 44 at the reference position, and By, which is the correction rotation angle.

The control unit 33 repeatedly executes the above control during optical communication. When the signal light deviates from the reference direction or the reference position even when the signal light finely vibrates at a high speed, the wedge prisms 41, 42, 43, and 44 rotate at rotation angles that eliminate the deviation. Such control processing and the rotation of the wedge prism are performed at a sufficiently high speed. Therefore, the optical communication optical system in the present embodiment can eliminate the influence of the fine vibration of the signal light on optical communication.

### MODIFIED EXAMPLE

In the present invention, in the above-described embodiment, the above-described light emitting element or light receiving element may be disposed instead of the optical fiber 20.

The target rotation angle of the wedge prism may be acquired on the basis of a detection value of another sensor capable of detecting vibration of the optical communication optical system. For example, the posture of the casing 10 may be detected by a detection value of an acceleration sensor such as a gyro sensor disposed in the casing 10, and the control unit 33 may acquire the target rotation angle of each wedge prism on the basis of the detection value. This form may not include the beam splitter 31 and the split photodiode 32, and can be substantially configured only by four groups of optical systems from the first group to the fourth group, and the target rotation angle can be obtained regardless of whether the signal light is the transmission light or the reception light.

Alternatively, the optical communication apparatus may further include a beam splitter that splits a part of the signal light from the fourth group 14 to the third group 13, and a mirror that guides the split signal light to the split photodiode 32. With such a configuration, it is possible to obtain the target rotation angle of each wedge prism from the output value of the split photodiode 32 in both the transmission light and the reception light.

The arrangement of the four wedge prisms in the direction of the optical axis OA is not limited. For example, the wedge prisms 41 and 42 constituting the wedge prism pair 131 and the wedge prisms 43 and 44 constituting the wedge prism pair 132 may be arranged in the order of “41, 43, 42, 44”, or may be arranged in the order of “41, 43, 44, 42”.

The apex angle a of the wedge prisms 41 and 42 in the wedge prism pair 131 and the apex angle b of the wedge prisms 43 and 44 in the wedge prism pair 132 may be the same or different. For example, when vibration in one direction on a plane orthogonal to the optical axis is more significant than vibration in multiple directions, the vertical angle of the wedge prism corresponding to the one direction may be further increased to further increase the sensitivity of deflection of the signal light in the one direction.

### SUMMARY

A first aspect of the present invention is an optical communication optical system disposed on an optical path of signal light emitted from a light emitting element and transmitted or signal light incident on a light receiving element and received, the optical communication optical system including a first group (11), a second group (12), a third group (13), and a fourth group (14) arranged in this order from a side opposite to the light emitting element or the light receiving element, wherein the first group changes a beam diameter of the signal light so as to be smaller at an end on a second group side in an optical axis direction, wherein the second group changes a beam diameter of the signal light so as to be smaller at an end on the third group side in the optical axis direction, wherein the third group includes two wedge prism pairs (131, 132), and the wedge prism pairs includes two wedge prisms (41, 42 or 43, 44) that rotate in opposite directions and at the same rotation angle, wherein the fourth group changes a beam diameter of the signal so as to be smaller at the end on the light emitting element side or the light receiving element side in the optical axis direction, and wherein Formulae (1) and (2) below are satisfied. In Formula (1), Ff represents the focal length (mm) of the first group and Bf represents the focal length (mm) of the second group, and in Formula (2), R represents the rotation angle of the wedge prism in one or the other wedge prism pair and a represents the apex angle of the wedge prism in one or the other wedge prism pair.

$$3.89 < Ff / Bf < 14. \qquad ( 1 )$$

$$0.09 < R / a < 6.565 \qquad ( 2 )$$

According to the first aspect, it is possible to easily prevent the vibration of the signal light in the optical communication optical system including the wedge prism.

A second aspect of the present invention satisfies Formula (3) in the first aspect. In Formula (3), C1 represents the movement amount (μm) of the focal position of the signal light having a wavelength of 1530 nm with reference to the focal position of the signal light having a wavelength of 1550 nm, and C2 represents the movement amount (μm) of the focal position of the signal light having a wavelength of 1565 nm with reference to the focal position of the signal light having a wavelength of 1550 nm.

$$\vert C 1 - C 2 \vert \leq 14.715 \qquad ( 3 )$$

The second aspect is more effective from the viewpoint of improving communication performance of optical communication in the C-band region.

A third aspect of the present invention satisfies Formula (4) in the first aspect or the second aspect. In Formula (4), n represents the refractive index of light having a wavelength of 1550 nm in the material of the wedge prism.

$$< Formula ( 4 ) >$$

$$1.4 < n < 1.674 \qquad ( 4 )$$

The third aspect is more effective from the viewpoint of improving the accuracy of vibration isolation of the signal light.

According to a fourth aspect of the present invention, in any one of the first to third aspects, the second group and the fourth group change the beam diameter of the signal light so that the signal light between both the groups becomes collimated light. The fourth aspect is more effective from the viewpoint of suppressing the deterioration of the communication performance due to the change in the spot shape of the signal light.

According to a fifth aspect of the present invention, in any one of the first to fourth aspects, at least any one of the first group, the second group, and the fourth group includes an aspherical lens. The fifth aspect is more effective from the viewpoint of suppressing the change in the beam diameter and the spot shape of the signal light at the time of vibration isolation.

A sixth aspect of the present invention is an optical communication apparatus including the optical communication optical system according to any one of the first to fifth aspects. According to the sixth aspect, it is possible to easily prevent the vibration of the signal light in the optical communication optical system including the wedge prism.

In recent years, radio wave communication technology has reached a theoretical upper limit, and in order to further increase the speed, a method of increasing the number of bands or increasing the frequency is considered. However, since the band of the radio wave is also congested internationally, it is difficult to increase the number of bands. In addition, since the straightness of the radio wave is increased when increasing the frequency, diffraction, which is an advantage of the radio wave, is less likely to occur, and the radio wave does not go around in a building or behind a building, so that communication quality cannot be secured. Therefore, a new measure such as movement or expansion of the base station is required. The wired communication is also difficult due to the problem of cost for installation or the problem of routing.

On the other hand, since signal light does not propagate in a wide range like a radio wave although the signal light has high straightness in optical communication, it is advantageous in terms of security. Similarly to the radio wave used for communication, the light is an electromagnetic wave, but can be freely used by anyone without being bound by the radio law.

Optical communication is generally considered to be disadvantageous for communication from or between moving objects. However, optical communication is considered to be advantageous as a technology for complementing communication by radio waves in communication in space between artificial satellites, and research in this field has been advanced. In the future, a more precise optical technology is expected to be required as optical wireless communication becomes faster and longer.

The optical communication apparatus and the optical communication optical system according to the present invention can achieve vibration isolation of signal light in optical communication in the C-band region with a simple configuration. The present invention having such effects is expected to contribute to the achievement of the goal 9 of the United Nations' sustainable development goal (SDGs), including, for example, tough infrastructure development, “to build the foundation of industry and technological innovation”.

The present invention is not limited to the above-described embodiments, and various modifications can be made within the scope of the claims. Embodiments obtained by combining as appropriate technical means disclosed in different embodiments are also included in the technical scope of the present invention.

### EXAMPLES

In the following examples, as the type in the table, the case of a spherical lens is denoted as “SPH”, and the case of an aspherical lens is denoted as “ASP”. In addition, “R” represents a curvature radius, “D” represents a lens thickness or a lens interval, “n1530” represents a refractive index at a wavelength of 1530 nm, “n1550” represents a refractive index at a wavelength of 1550 nm, and “n1565” represents a refractive index at a wavelength of 1565 nm.

The aspherical (ASP) even-order aspherical coefficient z is defined by the following formula. Here, “c” denotes the curvature (1/r), “h” denotes the height from the optical axis, “K” denotes the conic coefficient, and “A4”, “A6”, “A8”, and “A10” denote the aspheric coefficients of the respective orders.

$$< Formula >$$

$$z = {ch}^{2} / [ 1 + {\{ 1 - ( 1 + K ) {c}^{2} {h}^{2} \}}^{1 / 2} ] + A 4 {h}^{4} + A 6 {h}^{6} + A 8 {h}^{8} + A 10 {h}^{10}$$

In addition, in the following Tables, the units of lengths other than the wavelength are all “mm”. Further, “E-a” indicates “x10^{-a}”.

### Example 1

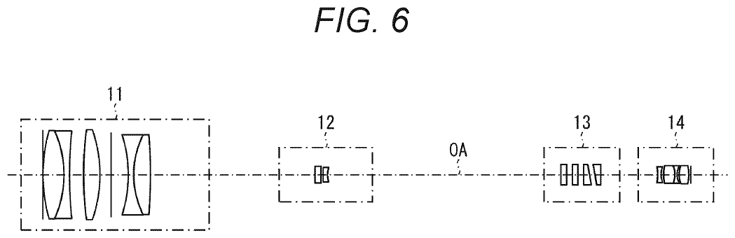

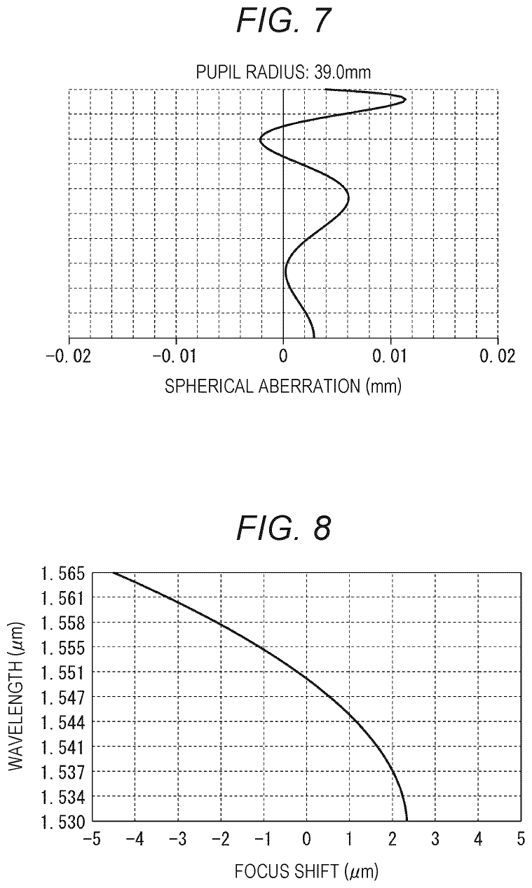

Hereinafter, an example of an optical communication optical system of the present invention will be described with reference to the drawings. FIG. 6 is a front view schematically illustrating a configuration of an optical communication optical system of Example 1, FIG. 7 is a spherical aberration diagram of the optical system in which the wedge prism is removed from the optical communication optical system of Example 1 at a wavelength of 1550 nm, and FIG. 8 is a diagram illustrating wavelength dependency of a focus shift amount at a wavelength of 1530 nm to 1565 nm of the optical communication optical system of Example 1. Table 1 illustrates numerical data of the optical communication optical system, and Table 2 illustrates numerical data of aspheric coefficients. In addition, Table 3 illustrates a rotation angle with respect to each apex angle of the wedge prism for vibration-isolation correction of a vibration angle of 100 mrad and numerical data of Formula (2) at that time. In the present embodiment and the following embodiment, all the wedge prisms arranged in the optical system have the same vertical angle and rotate at the same rotation angle (absolute value). In Table 1, surface numbers 1 to 10 represent a first group, surface numbers 11 to 14 represent a second group, surface numbers 15 to 22 represent a third group, and surface numbers 23 to 29 represent a fourth group. The first group and the second group in the optical communication optical system of Example 1 constitute a Galilean optical system.

TABLE 1

| Surface | | | | | | |
|---|---|---|---|---|---|---|
| number | Type | R | D | n1530 | n1550 | n1565 |
| 1 | STO | INF | 0 | | | |
| 2 | SPH | 149.675 | 18.367 | 1.50122 | 1.50099 | 1.50088 |
| 3 | SPH | −94.791 | 5.000 | 1.79930 | 1.79885 | 1.79863 |
| 4 | SPH | 412.690 | 12.169 | | | |
| 5 | SPH | 286.055 | 14.243 | 1.50122 | 1.50088 | 1.50088 |
| 6 | SPH | −124.439 | 10.000 | | | |
| 7 | SPH | INF | 14.993 | | | |
| 8 | SPH | −118.238 | 5.000 | 1.50122 | 1.50065 | 1.50088 |
| 9 | SPH | 78.758 | 14.464 | 1.76444 | 1.76413 | 1.76398 |
| 10 | SPH | −531.641 | 144.766 | | | |
| 11 | ASP | 312.917 | 5.000 | 1.50122 | 1.50065 | 1.50088 |
| 12 | ASP | 66.869 | 2.000 | | | |
| 13 | SPH | INE | 4.000 | 1.50122 | 1.50065 | 1.50088 |
| 14 | SPH | 21.310 | 200.000 | | | |
| 15 | SPH | INF | 5.000 | 1.44426 | 1.44402 | 1.44390 |
| 16 | SPH | INF | 5.000 | | | |
| 17 | SPH | INF | 5.000 | 1.44426 | 1.44402 | 1.44390 |
| 18 | SPH | INF | 5.000 | | | |
| 19 | SPH | INF | 5.000 | 1.44426 | 1.44402 | 1.44390 |
| 20 | SPH | INF | 5.000 | | | |
| 21 | SPH | INF | 5.000 | 1.44426 | 1.44402 | 1.44390 |
| 22 | SPH | INF | 50.000 | | | |
| 23 | SPH | −28.107 | 3.000 | 1.50122 | 1.50065 | 1.50088 |
| 24 | SPH | 19.812 | 2.000 | | | |
| 25 | SPH | 24.377 | 10.000 | 1.76444 | 1.76413 | 1.76398 |
| 26 | SPH | −19.730 | 2.000 | 1.50122 | 1.50065 | 1.50088 |
| 27 | SPH | 14.793 | 2.000 | | | |
| 28 | SPH | 20.610 | 8.000 | 1.76444 | 1.76413 | 1.76398 |
| 29 | ASP | −105.469 | 53.987 | | | |

TABLE 2

| Surface | | | | | |
|---|---|---|---|---|---|
| number | K | A4 | A6 | A8 | A10 |
| 11 | 0.000 | −1.807E−05 | −2.735E−07 | −1.001E−09 | −2.258E−11 |
| 12 | 0.000 | −1.936E−05 | −3.710E−07 | −4.486E−09 | −1.910E−13 |
| 29 | 0.000 | −2.037E−06 | −3.416E−08 | −4.865E−11 | −1.207E−12 |

TABLE 3

| Vertical angle (°) | Rotation angle (°) | Formula (2) |
|---|---|---|
| 2 | 12.814 | 6.407 |
| 4 | 6.354 | 1.589 |
| 6 | 4.217 | 0.703 |
| 8 | 3.106 | 0.388 |
| 10 | 2.501 | 0.250 |
| 12 | 2.068 | 0.172 |
| 14 | 1.756 | 0.125 |
| 16 | 1.519 | 0.095 |

### Example 2

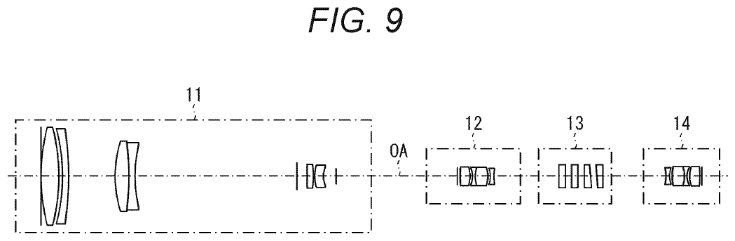

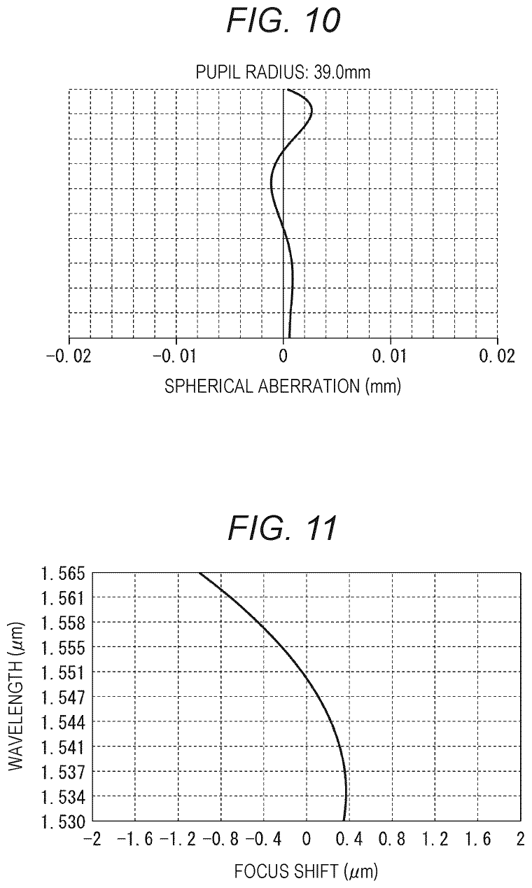

FIG. 9 is a front view schematically illustrating a configuration of an optical communication optical system of Example 2, FIG. 10 is a spherical aberration diagram of the optical system in which the wedge prism is removed from the optical communication optical system of Example 2 at a wavelength of 1550 nm, and FIG. 11 is a diagram illustrating wavelength dependency of a focus shift amount at a wavelength of 1530 nm to 1565 nm of the optical communication optical system of Example 2. In addition, Table 4 represents numerical data of the optical communication optical system, Table 5 represents numerical data of the aspheric coefficient, and Table 6 represents a rotation angle with respect to each apex angle for vibration isolation correction of the vibration angle of 100 mrad of the wedge prism and numerical data of Formula (2) at that time. In Table 4, surface numbers 1 to 13 represent a first group, surface numbers 14 to 21 represent a second group, surface numbers 22 to 29 represent a third group, and surface numbers 30 to 36 represent a fourth group. The first group and the second group in the optical communication optical system of Example 2 constitute a Keplerian optical system.

TABLE 4

| Surface | | | | | | |
|---|---|---|---|---|---|---|
| number | Type | R | D | n1530 | n1550 | n1565 |
| 1 | STO | INF | 0 | | | |
| 2 | SPH | 161.898 | 14.000 | 1.60019 | 1.59993 | 1.59980 |
| 3 | SPH | −161.898 | 3.000 | | | |
| 4 | SPH | −149.438 | 5.032 | 1.79930 | 1.79885 | 1.79863 |
| 5 | SPH | −247.836 | 37.000 | | | |
| 6 | SPH | 90.591 | 11.000 | 1.50122 | 1.50099 | 1.50088 |
| 7 | SPH | −200.913 | 5.000 | 1.91169 | 1.91103 | 1.91070 |
| 8 | SPH | 120.161 | 129.031 | | | |
| 9 | SPH | INF | 8.035 | | | |
| 10 | SPH | −216.546 | 5.000 | 1.50122 | 1.50099 | 1.50088 |
| 11 | SPH | −61.786 | 1.133 | | | |
| 12 | SPH | 26.886 | 7.000 | 1.79930 | 1.79885 | 1.79863 |
| 13 | SPH | 18.887 | 54.770 | | | |
| 14 | SPH | INF | 53.986 | | | |
| 15 | ASP | 105.469 | 8.000 | 1.76444 | 1.76413 | 1.76398 |
| 16 | SPH | −20.610 | 2.000 | | | |
| 17 | SPH | −14.793 | 2.000 | 1.50122 | 1.50099 | 1.50088 |
| 18 | SPH | 19.730 | 10.000 | 1.76444 | 1.76413 | 1.76398 |
| 19 | SPH | −24.377 | 2.000 | | | |
| 20 | SPH | −19.812 | 3.000 | 1.50122 | 1.50099 | 1.50088 |
| 21 | SPH | 28.107 | 50.000 | | | |
| 22 | SPH | INF | 5.000 | 1.44426 | 1.44402 | 1.44390 |
| 23 | SPH | INF | 5.000 | | | |
| 24 | SPH | INF | 5.000 | 1.44426 | 1.44402 | 1.44390 |
| 25 | SPH | INF | 5.000 | | | |
| 26 | SPH | INF | 5.000 | 1.44426 | 1.44402 | 1.44390 |
| 27 | SPH | INF | 5.000 | | | |
| 28 | SPH | INF | 5.000 | 1.44426 | 1.44402 | 1.44390 |
| 29 | SPH | INF | 50.000 | | | |
| 30 | SPH | −28.107 | 3.000 | 1.50122 | 1.50099 | 1.50088 |
| 31 | SPH | 19.812 | 2.000 | | | |
| 32 | SPH | 24.377 | 10.000 | 1.76444 | 1.76413 | 1.76398 |
| 33 | SPH | −19.730 | 2.000 | 1.50122 | 1.50099 | 1.50088 |
| 34 | SPH | 14.793 | 2.000 | | | |
| 35 | SPH | 20.610 | 8.000 | 1.76444 | 1.76413 | 1.76398 |
| 36 | ASP | −105.469 | 53.986 | | | |

TABLE 5

| Surface | | | | | |
|---|---|---|---|---|---|
| number | K | A4 | A6 | A8 | A10 |
| 15 | 0.000 | 2.037E−06 | 3.416E−08 | 4.865E−11 | 1.207E−12 |
| 36 | 0.000 | −2.037E−06 | −3.416E−08 | −4.865E−11 | −1.207E−12 |

TABLE 6

| Vertical | Rotation | Formula |
|---|---|---|
| angle (°) | angle (°) | (2) |
| 2 | 12.660 | 6.330 |
| 4 | 6.278 | 1.570 |
| 6 | 4.167 | 0.695 |
| 8 | 3.109 | 0.389 |
| 10 | 2.471 | 0.247 |
| 12 | 2.043 | 0.170 |
| 14 | 1.735 | 0.124 |
| 16 | 1.501 | 0.094 |

### Example 3

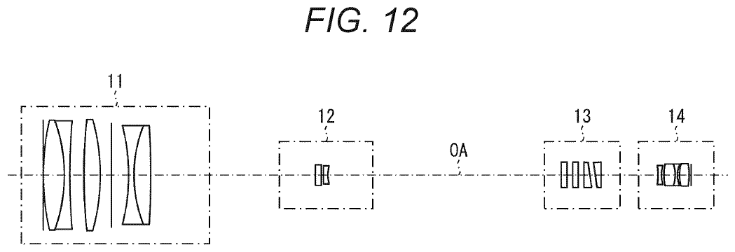

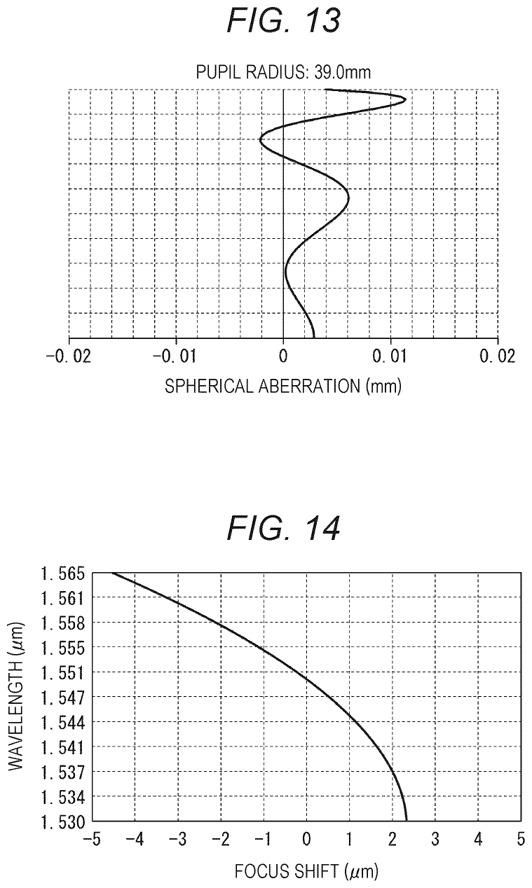

FIG. 12 is a front view schematically illustrating a configuration of an optical communication optical system of Example 3, FIG. 13 is a spherical aberration diagram of the optical system in which the wedge prism is removed from the optical communication optical system of Example 3 at a wavelength of 1550 nm, and FIG. 14 is a diagram illustrating wavelength dependency of the focus shift amount in the wavelength of 1530 nm to 1565 nm of the optical communication optical system of Example 3. In addition, Table 7 illustrates numerical data of the optical communication optical system, Table 8 illustrates numerical data of aspheric coefficients, and Table 9 illustrates rotation angles with respect to each apex angle for vibration isolation correction of a vibration angle of 100 mrad of the wedge prism and numerical data of Formula (2) at that time. In Table 7, surface numbers 1 to 10 represent a first group, surface numbers 11 to 14 represent a second group, surface numbers 15 to 22 represent a third group, and surface numbers 23 to 29 represent a fourth group. The first group and the second group in the optical communication optical system of Example 3 constitute a Galilean optical system.

TABLE 7

| Surface | | | | | | |
|---|---|---|---|---|---|---|
| number | Type | R | D | n1530 | n1550 | n1565 |
| 1 | STO | INF | 0 | | | |
| 2 | SPH | 149.675 | 18.367 | 1.50122 | 1.50099 | 1.50088 |
| 3 | SPH | −94.791 | 5.000 | 1.79930 | 1.79885 | 1.79863 |
| 4 | SPH | 412.690 | 12.169 | | | |
| 5 | SPH | 286.055 | 14.243 | 1.50122 | 1.50088 | 1.50088 |
| 6 | SPH | −124.439 | 10.000 | | | |
| 7 | SPH | INF | 14.993 | | | |
| 8 | SPH | −118.238 | 5.000 | 1.50122 | 1.50065 | 1.50088 |
| 9 | SPH | 78.758 | 14.464 | 1.76444 | 1.76413 | 1.76398 |
| 10 | SPH | −531.641 | 144.766 | | | |
| 11 | ASP | 312.917 | 5.000 | 1.50122 | 1.50065 | 1.50088 |
| 12 | ASP | 66.869 | 2.000 | | | |
| 13 | SPH | INF | 4.000 | 1.50122 | 1.50065 | 1.50088 |
| 14 | SPH | 21.310 | 200.000 | | | |
| 15 | SPH | INF | 5.000 | 1.673939 | 1.673623 | 1.673465 |
| 16 | SPH | INF | 5.000 | | | |
| 17 | SPH | INF | 5.000 | 1.673939 | 1.673623 | 1.673465 |
| 18 | SPH | INF | 5.000 | | | |
| 19 | SPH | INF | 5.000 | 1.673939 | 1.673623 | 1.673465 |
| 20 | SPH | INF | 5.000 | | | |
| 21 | SPH | INF | 5.000 | 1.673939 | 1.673623 | 1.673465 |
| 22 | SPH | INF | 50.000 | | | |
| 23 | SPH | −28.107 | 3.000 | 1.50122 | 1.50065 | 1.50088 |
| 24 | SPH | 19.812 | 2.000 | | | |
| 25 | SPH | 24.377 | 10.000 | 1.76444 | 1.76413 | 1.76398 |
| 26 | SPH | −19.730 | 2.000 | 1.50122 | 1.50065 | 1.50088 |
| 27 | SPH | 14.793 | 2.000 | | | |
| 28 | SPH | 20.610 | 8.000 | 1.76444 | 1.76413 | 1.76398 |
| 29 | ASP | −105.469 | 53.987 | | | |

TABLE 8

| Surface | | | | | |
|---|---|---|---|---|---|
| number | K | A4 | A6 | A8 | A10 |
| 11 | 0.000 | −1.807E−05 | −2.735E−07 | −1.001E−09 | −2.258E−11 |
| 12 | 0.000 | −1.936E−05 | −3.710E−07 | −4.486E−09 | −1.910E−13 |
| 29 | 0.000 | −2.037E−06 | −3.416E−08 | −4.865E−11 | −1.207E−12 |

TABLE 9

| Vertical | Rotation | |
|---|---|---|
| angle (°) | angle (°) | Formula (2) |
| 2 | 8.405 | 4.203 |
| 4 | 4.181 | 1.045 |
| 6 | 2.774 | 0.462 |
| 8 | 2.068 | 0.259 |
| 10 | 1.642 | 0.164 |
| 12 | 1.355 | 0.113 |
| 13 | 1.244 | 0.096 |

### Example 4

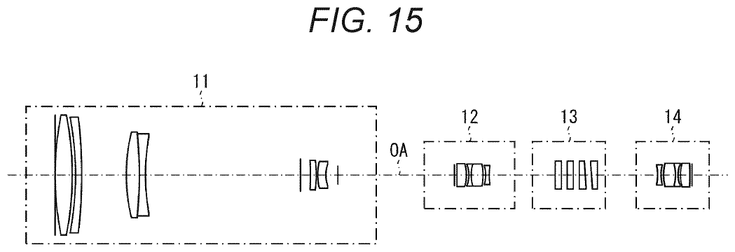

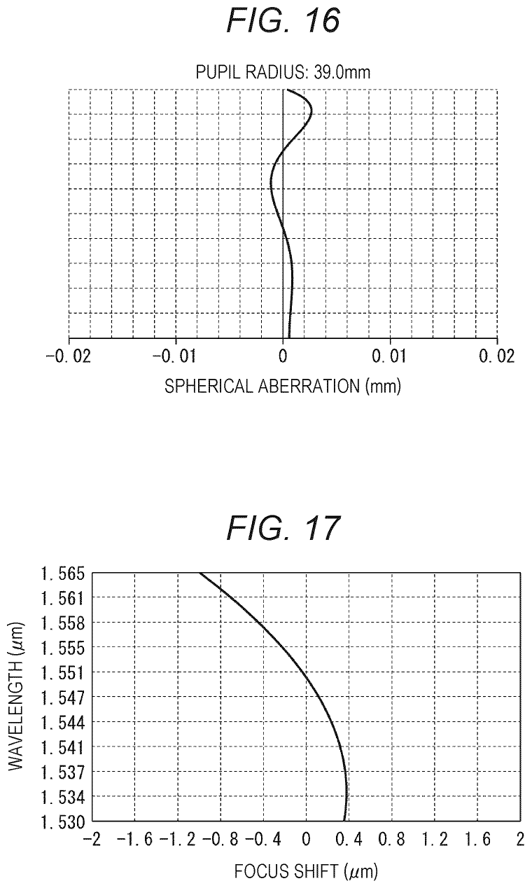

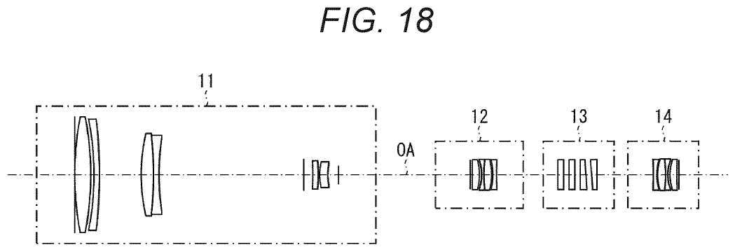

FIG. 15 is a front view schematically illustrating a configuration of an optical communication optical system of Example 4, FIG. 16 is a spherical aberration diagram of the optical system in which a wedge prism is removed from the optical communication optical system of Example 4 at a wavelength of 1550 nm, and FIG. 17 is a diagram illustrating wavelength dependency of a focus shift amount at a wavelength of 1530 nm to 1565 nm of the optical communication optical system of Example 4. Table 10 illustrates numerical data of the optical communication optical system, Table 11 illustrates numerical data of aspheric coefficients, and Table 12 illustrates rotation angles with respect to each apex angle for vibration isolation correction of the vibration angle of 100 mrad of the wedge prism and numerical data of Formula (2) at that time. In Table 10, surface numbers 1 to 13 represent a first group, surface numbers 14 to 21 represent a second group, surface numbers 22 to 29 represent a third group, and surface numbers 30 to 36 represent a fourth group. The first group and the second group in the optical communication optical system of Example 4 constitute a Keplerian optical system.

TABLE 10

| Surface | | | | | | |
|---|---|---|---|---|---|---|
| number | Type | R | D | n1530 | n1550 | n1565 |
| 1 | STO | INF | 0 | | | |
| 2 | SPH | 161.898 | 14.000 | 1.60019 | 1.59993 | 1.59980 |
| 3 | SPH | −161.898 | 3.000 | | | |
| 4 | SPH | −149.438 | 5.032 | 1.79930 | 1.79885 | 1.79863 |
| 5 | SPH | −247.836 | 37.000 | | | |
| 6 | SPH | 90.591 | 11.000 | 1.50122 | 1.50099 | 1.50088 |
| 7 | SPH | −200.913 | 5.000 | 1.91169 | 1.91103 | 1.91070 |
| 8 | SPH | 120.161 | 129.031 | | | |
| 9 | SPH | INE | 8.035 | | | |
| 10 | SPH | −216.546 | 5.000 | 1.50122 | 1.50099 | 1.50088 |
| 11 | SPH | −61.786 | 1.133 | | | |
| 12 | SPH | 26.886 | 7.000 | 1.79930 | 1.79885 | 1.79863 |
| 13 | SPH | 18.887 | 54.770 | | | |
| 14 | SPH | INF | 53.986 | | | |
| 15 | ASP | 105.469 | 8.000 | 1.76444 | 1.76413 | 1.76398 |
| 16 | SPH | −20.610 | 2.000 | | | |
| 17 | SPH | −14.793 | 2.000 | 1.50122 | 1.50099 | 1.50088 |
| 18 | SPH | 19.730 | 10.000 | 1.76444 | 1.76413 | 1.76398 |
| 19 | SPH | −24.377 | 2.000 | | | |
| 20 | SPH | −19.812 | 3.000 | 1.50122 | 1.50099 | 1.50088 |
| 21 | SPH | 28.107 | 50.000 | | | |
| 22 | SPH | INF | 5.000 | 1.42855 | 1.42843 | 1.42837 |
| 23 | SPH | INE | 5.000 | | | |
| 24 | SPH | INF | 5.000 | 1.42855 | 1.42843 | 1.42837 |
| 25 | SPH | INF | 5.000 | | | |
| 26 | SPH | INF | 5.000 | 1.42855 | 1.42843 | 1.42837 |
| 27 | SPH | INF | 5.000 | | | |
| 28 | SPH | INF | 5.000 | 1.42855 | 1.42843 | 1.42837 |
| 29 | SPH | INE | 50.000 | | | |
| 30 | SPH | −28.107 | 3.000 | 1.50122 | 1.50099 | 1.50088 |
| 31 | SPH | 19.812 | 2.000 | | | |
| 32 | SPH | 24.377 | 10.000 | 1.76444 | 1.76413 | 1.76398 |
| 33 | SPH | −19.730 | 2.000 | 1.50122 | 1.50099 | 1.50088 |
| 34 | SPH | 14.793 | 2.000 | | | |
| 35 | SPH | 20.610 | 8.000 | 1.76444 | 1.76413 | 1.76398 |
| 36 | ASP | −105.469 | 53.986 | | | |

TABLE 11

| Surface | | | | | |
|---|---|---|---|---|---|
| number | K | A4 | A6 | A8 | A10 |
| 15 | 0.000 | 2.037E−06 | 3.416E−08 | 4.865E−11 | 1.207E−12 |
| 36 | 0.000 | −2.037E−06 | −3.416E−08 | −4.865E−11 | −1.207E−12 |

TABLE

| Vertical | Rotation | |
|---|---|---|
| angle (°) | angle (°) | Formula (2) |
| 2 | 13.129 | 6.565 |
| 4 | 6.508 | 1.627 |
| 6 | 4.319 | 0.720 |
| 8 | 3.222 | 0.403 |
| 10 | 2.562 | 0.256 |
| 12 | 2.118 | 0.177 |
| 14 | 1.799 | 0.129 |
| 16 | 1.557 | 0.097 |
| 16.6 | 1.495 | 0.090 |

### Example 5

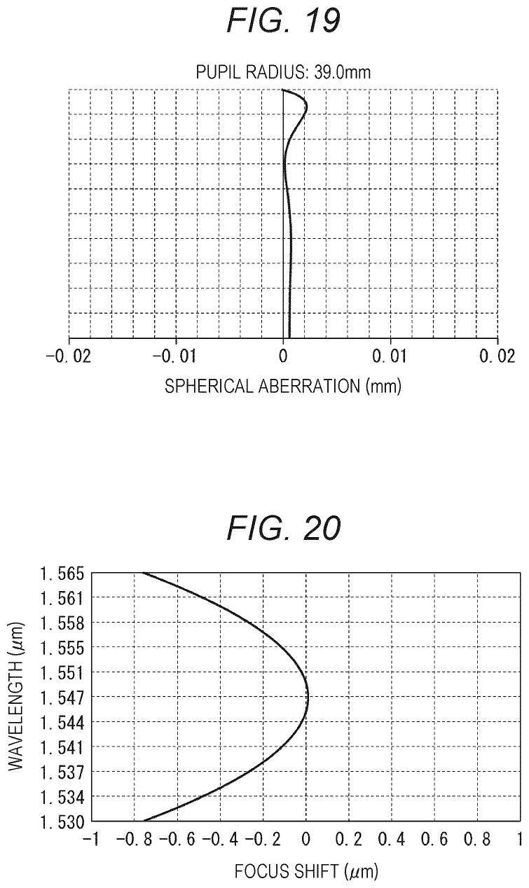

FIG. 18 is a front view schematically illustrating a configuration of an optical communication optical system of Example 5, FIG. 19 is a spherical aberration diagram of the optical system in which a wedge prism is removed from the optical communication optical system of Example 5 at a wavelength of 1550 nm, and FIG. 20 is a diagram illustrating wavelength dependency of a focus shift amount at a wavelength of 1530 nm to 1565 nm of the optical communication optical system of Example 5. Table 13 illustrates numerical data of the optical communication optical system, Table 14 illustrates numerical data of aspheric coefficients, and Table 15 illustrates rotation angles with respect to each apex angle for vibration isolation correction of the vibration angle of 100 mrad of the wedge prism and numerical data of Formula (2) at that time. In Table 13, surface numbers 1 to 12 represent a first group, surface numbers 13 to 20 represent a second group, surface numbers 21 to 28 represent a third group, and surface numbers 29 to 35 represent a fourth group. The first group and the second group in the optical communication optical system of Example 5 constitute a Keplerian optical system.

TABLE 13

| Surface | | | | | | |
|---|---|---|---|---|---|---|
| number | Type | R | D | n1530 | n1550 | n1565 |
| 1 | STO | INE | 0 | | | |
| 2 | SPH | 161.898 | 14.000 | 1.60019 | 1.59993 | 1.59980 |
| 3 | SPH | −161.898 | 3.000 | | | |
| 4 | SPH | −149.438 | 5.032 | 1.79930 | 1.79885 | 1.79863 |
| 5 | SPH | −247.836 | 37.000 | | | |
| 6 | SPH | 90.591 | 11.000 | 1.50122 | 1.50099 | 1.50088 |
| 7 | SPH | −200.913 | 5.000 | 1.91169 | 1.91103 | 1.91070 |
| 8 | SPH | 120.161 | 137.066 | | | |
| 9 | SPH | −216.546 | 5.000 | 1.50122 | 1.50099 | 1.50088 |
| 10 | SPH | −61.786 | 1.133 | | | |
| 11 | SPH | 26.886 | 7.000 | 1.79930 | 1.79885 | 1.79863 |
| 12 | SPH | 18.887 | 54.770 | | | |
| 13 | SPH | INF | 74.688 | | | |
| 14 | SPH | −312.954 | 6.000 | 1.76444 | 1.76413 | 1.76398 |
| 15 | ASP | −28.120 | 2.000 | | | |
| 16 | SPH | −22.445 | 2.000 | 1.50122 | 1.50099 | 1.50088 |
| 17 | SPH | 62.550 | 7.000 | 1.76444 | 1.76413 | 1.76398 |
| 18 | SPH | −27.409 | 1.000 | | | |
| 19 | SPH | −27.023 | 3.000 | 1.50122 | 1.50099 | 1.50088 |
| 20 | SPH | 109.433 | 50.000 | | | |
| 21 | SPH | INF | 5.000 | 1.42855 | 1.42843 | 1.42837 |
| 22 | SPH | INF | 5.000 | | | |
| 23 | SPH | INF | 5.000 | 1.42855 | 1.42843 | 1.42837 |
| 24 | SPH | INF | 5.000 | | | |
| 25 | SPH | INF | 5.000 | 1.42855 | 1.42843 | 1.42837 |
| 26 | SPH | INF | 5.000 | | | |
| 27 | SPH | INF | 5.000 | 1.42855 | 1.42843 | 1.42837 |
| 28 | SPH | INF | 50.000 | | | |
| 29 | SPH | −109.433 | 3.000 | 1.50122 | 1.50099 | 1.50088 |
| 30 | SPH | 27.023 | 1.000 | | | |
| 31 | SPH | 27.409 | 7.000 | 1.76444 | 1.76413 | 1.76398 |
| 32 | SPH | −62.550 | 2.000 | 1.50122 | 1.50099 | 1.50088 |
| 33 | SPH | 22.445 | 2.000 | | | |
| 34 | SPH | 28.120 | 6.000 | 1.76444 | 1.76413 | 1.76398 |
| 35 | ASP | 312.954 | 74.688 | | | |

TABLE 14

| Surface | | | | | |
|---|---|---|---|---|---|
| number | K | A4 | A6 | A8 | A10 |
| 14 | 0.000 | −1.663E−06 | 1.158E−10 | −8.842E−13 | −2.575E−14 |
| 35 | 0.000 | 1.663E−06 | −1.158E−10 | 8.842E−13 | 2.575E−14 |

TABLE 15

| Vertical angle (°) | Rotation angle (°) | Formula (2) |
|---|---|---|
| 2 | 7.557 | 3.779 |
| 4 | 3.763 | 0.941 |
| 6 | 2.499 | 0.417 |
| 8 | 1.865 | 0.233 |
| 10 | 1.482 | 0.148 |
| 12 | 1.226 | 0.102 |
| 12.78 | 1.147 | 0.090 |

### Example 6

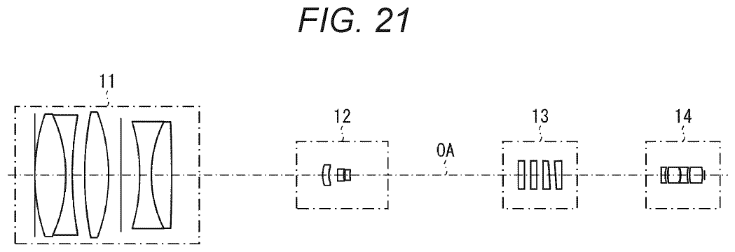

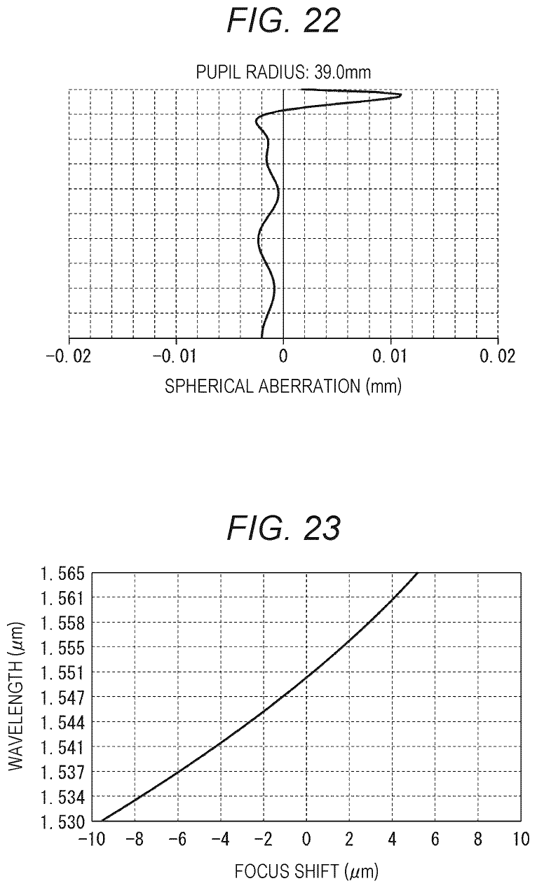

FIG. 21 is a front view schematically illustrating a configuration of an optical communication optical system of Example 6, FIG. 22 is a spherical aberration diagram of an optical system in which a wedge prism is removed from the optical communication optical system of Example 6 at a wavelength of 1550 nm, and FIG. 23 is a diagram illustrating wavelength dependency of a focus shift amount at a wavelength of 1530 nm to 1565 nm of the optical communication optical system of Example 6. Table 16 illustrates numerical data of the optical communication optical system, Table 17 illustrates numerical data of aspheric coefficients, and Table 18 illustrates rotation angles with respect to each apex angle for vibration isolation correction of the vibration angle of 100 mrad of the wedge prism and numerical data of Formula (2) at that time. In Table 16, surface numbers 1 to 9 represent a first group, surface numbers 10 to 15 represent a second group, surface numbers 16 to 23 represent a third group, and surface numbers 24 to 31 represent a fourth group. The first group and the second group in the optical communication optical system of Example 6 constitute a Galilean optical system.

TABLE 16

| Surface | | | | | | |
|---|---|---|---|---|---|---|
| number | Type | R | D | n1530 | n1550 | n1565 |
| 1 | SPH | INF | 0 | | | |
| 2 | SPH | 96.726 | 24.809 | 1.501223 | 1.500992 | 1.500876 |
| 3 | SPH | −73.209 | 5.000 | 1.79930 | 1.79885 | 1.79863 |
| 4 | SPH | 157.840 | 10.000 | | | |
| 5 | SPH | 158.340 | 19.288 | 1.501223 | 1.500992 | 1.500876 |
| 6 | SPH | −92.659 | 24.993 | | | |
| 7 | SPH | −100.210 | 9.311 | 1.501223 | 1.500992 | 1.500876 |
| 8 | SPH | 63.019 | 16.334 | 1.76444 | 1.76413 | 1.76398 |
| 9 | SPH | −774.368 | 121.271 | | | |
| 10 | ASP | 19.985 | 5.000 | 1.501223 | 1.500992 | 1.500876 |
| 11 | ASP | 13.894 | 6.860 | | | |
| 12 | ASP | 27.312 | 5.000 | 1.76444 | 1.76413 | 1.76398 |
| 13 | SPH | 16.408 | 1.035 | | | |
| 14 | SPH | 1276.950 | 4.000 | 1.76444 | 1.76413 | 1.76398 |
| 15 | SPH | 17.992 | 130.000 | | | |
| 16 | SPH | INF | 5.000 | 1.44426 | 1.44402 | 1.44390 |
| 17 | SPH | INF | 5.000 | | | |
| 18 | SPH | INF | 5.000 | 1.44426 | 1.44402 | 1.44390 |
| 19 | SPH | INE | 5.000 | | | |
| 20 | SPH | INF | 5.000 | 1.44426 | 1.44402 | 1.44390 |
| 21 | SPH | INF | 5.000 | | | |
| 22 | SPH | INF | 5.000 | 1.44426 | 1.44402 | 1.44390 |
| 23 | SPH | INF | 80.000 | | | |
| 24 | SPH | −151.718 | 3.000 | 1.501223 | 1.500992 | 1.500876 |
| 25 | SPH | 12.897 | 2.000 | | | |
| 26 | SPH | 18.969 | 10.000 | 1.76444 | 1.76413 | 1.76398 |
| 27 | SPH | −12.679 | 0.700 | | | |
| 28 | SPH | −10.966 | 5.000 | 1.501223 | 1.500992 | 1.500876 |
| 29 | SPH | 13.508 | 2.000 | | | |
| 30 | SPH | 20.361 | 10.000 | 1.76444 | 1.76413 | 1.76398 |
| 31 | ASP | −139.791 | 33.697 | | | |

TABLE 17

| Surface | | | | | |
|---|---|---|---|---|---|
| number | K | A4 | A6 | A8 | A10 |
| 10 | 0.000 | 1.087E−04 | 1.004E−06 | 4.219E−08 | −2.913E−10 |
| 11 | 0.000 | 2.001E−04 | 2.191E−06 | 1.223E−07 | 6.758E−09 |
| 12 | 0.000 | −6.785E−04 | −2.348E−05 | −5.748E−07 | 4.073E−08 |
| 13 | 0.000 | −1.211E−03 | −4.482E−05 | 2.825E−06 | −4.354E−08 |
| 14 | 0.000 | −2.780E−05 | −4.829E−07 | −1.652E−09 | 2.205E−11 |

TABLE 18

| Vertical angle (°) | Rotation angle (°) | Formula (2) |
|---|---|---|
| 2.81 | 18.195 | 6.475 |
| 4 | 12.653 | 3.163 |
| 6 | 8.368 | 1.395 |
| 8 | 6.236 | 0.780 |
| 10 | 4.954 | 0.495 |
| 12 | 4.094 | 0.341 |
| 14 | 3.476 | 0.248 |
| 16 | 3.007 | 0.188 |
| 18 | 2.639 | 0.147 |
| 20 | 2.340 | 0.117 |

### Example 7

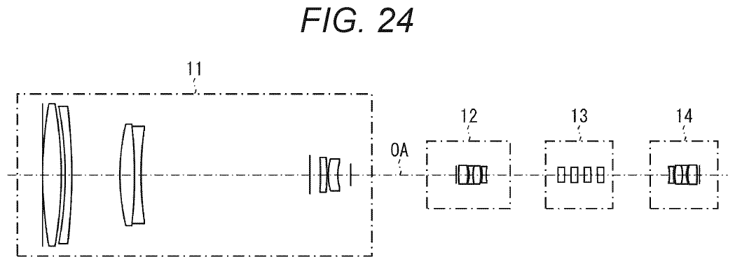

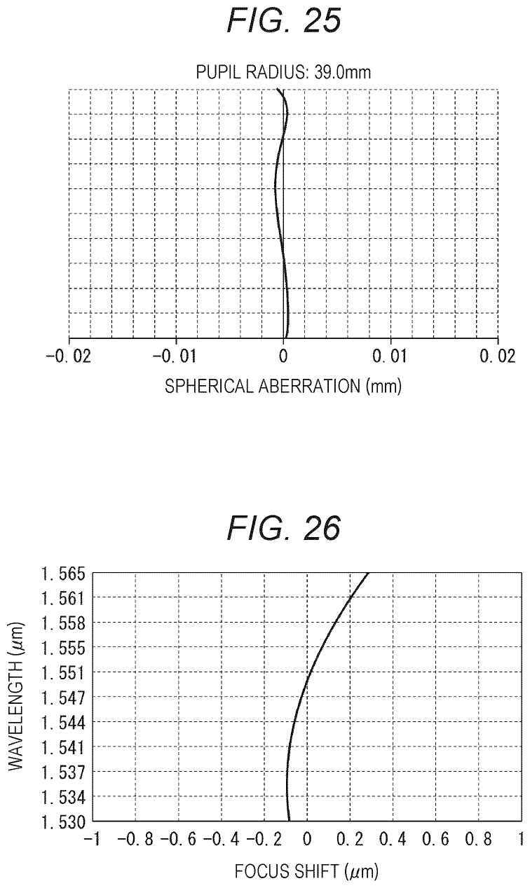

FIG. 24 is a front view schematically illustrating a configuration of an optical communication optical system of Example 7, FIG. 25 is a spherical aberration diagram of the optical system in which the wedge prism is removed from the optical communication optical system of Example 7 at a wavelength of 1550 nm, and FIG. 26 is a diagram illustrating wavelength dependency of the focus shift amount in the wavelength of 1530 nm to 1565 nm of the optical communication optical system of Example 7. Table 19 illustrates numerical data of the optical communication optical system, Table 20 illustrates numerical data of aspheric coefficients, and Table 21 illustrates rotation angles with respect to each apex angle for vibration isolation correction of the vibration angle of 100 mrad of the wedge prism and numerical data of Formula (2) at that time. In Table 19, surface numbers 1 to 13 represent a first group, surface numbers 14 to 21 represent a second group, surface numbers 22 to 29 represent a third group, and surface numbers 30 to 36 represent a fourth group. The first group and the second group in the optical communication optical system of Example 7 constitute a Keplerian optical system.

TABLE 19

| Surface | | | | | | |
|---|---|---|---|---|---|---|
| number | Type | R | D | n1530 | n1550 | n1565 |
| 1 | STO | INF | 0 | | | |
| 2 | SPH | 161.898 | 14.000 | 1.60019 | 1.59993 | 1.59980 |
| 3 | SPH | −161.898 | 3.000 | | | |
| 4 | SPH | −149.438 | 5.032 | 1.79930 | 1.79885 | 1.79863 |
| 5 | SPH | −247.836 | 37.000 | | | |
| 6 | SPH | 90.591 | 11.000 | 1.50122 | 1.50099 | 1.50088 |
| 7 | SPH | −200.913 | 5.000 | 1.91169 | 1.91103 | 1.91070 |
| 8 | SPH | 120.161 | 129.031 | | | |
| 9 | SPH | 0.000 | 8.035 | | | |
| 10 | SPH | −216.546 | 5.000 | 1.501223 | 1.500992 | 1.500876 |
| 11 | SPH | −61.786 | 1.133 | | | |
| 12 | SPH | 26.886 | 7.000 | 1.799296 | 1.798853 | 1.798632 |
| 13 | SPH | 18.887 | 54.770 | | | |
| 14 | SPH | INF | 37.615 | | | |
| 15 | ASP | 43.635 | 7.000 | 1.764439 | 1.764133 | 1.763981 |
| 16 | SPH | −16.150 | 1.066 | | | |
| 17 | SPH | −12.014 | 3.000 | 1.501223 | 1.500992 | 1.500876 |
| 18 | SPH | 13.328 | 6.000 | 1.764439 | 1.764133 | 1.763981 |
| 19 | SPH | −17.670 | 1.000 | | | |
| 20 | SPH | −14.335 | 3.000 | 1.501223 | 1.500992 | 1.500876 |
| 21 | SPH | 14.532 | 50.000 | | | |
| 22 | SPH | INF | 5.000 | 1.44426 | 1.44402 | 1.44390 |
| 23 | SPH | INF | 5.000 | | | |
| 24 | SPH | INF | 5.000 | 1.44426 | 1.44402 | 1.44390 |
| 25 | SPH | INF | 5.000 | | | |
| 26 | SPH | INF | 5.000 | 1.44426 | 1.44402 | 1.44390 |
| 27 | SPH | INF | 5.000 | | | |
| 28 | SPH | INE | 5.000 | 1.44426 | 1.44402 | 1.44390 |
| 29 | SPH | INF | 50.000 | | | |
| 30 | SPH | −14.532 | 3.000 | 1.501223 | 1.500992 | 1.500876 |
| 31 | SPH | 14.335 | 1.000 | | | |
| 32 | SPH | 17.670 | 6.000 | 1.764439 | 1.764133 | 1.763981 |
| 33 | SPH | −13.328 | 3.000 | 1.501223 | 1.500992 | 1.500876 |
| 34 | SPH | 12.014 | 1.066 | | | |
| 35 | SPH | 16.150 | 7.000 | 1.764439 | 1.764133 | 1.763981 |
| 36 | ASP | −43.635 | 37.615 | | | |

TABLE 20

| Surface | | | | | |
|---|---|---|---|---|---|
| number | K | A4 | A6 | A8 | A10 |
| 14 | 0.000 | −3.026E−06 | 1.246E−07 | 5.631E−10 | 1.079E−11 |
| 35 | 0.000 | 3.026E−06 | −1.246E−07 | −5.631E−10 | −1.079E−11 |

TABLE 21

| Vertical angle (°) | Rotation angle (°) | Formula (2) |
|---|---|---|
| 2.43 | 18.195 | 7.488 |
| 6 | 12.653 | 2.109 |
| 8 | 8.368 | 1.046 |
| 10 | 6.236 | 0.624 |
| 12 | 4.954 | 0.413 |
| 14 | 4.094 | 0.292 |
| 16 | 3.476 | 0.217 |
| 18 | 3.007 | 0.167 |

### Example 8

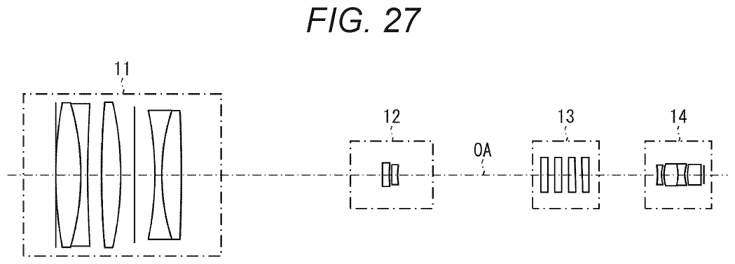

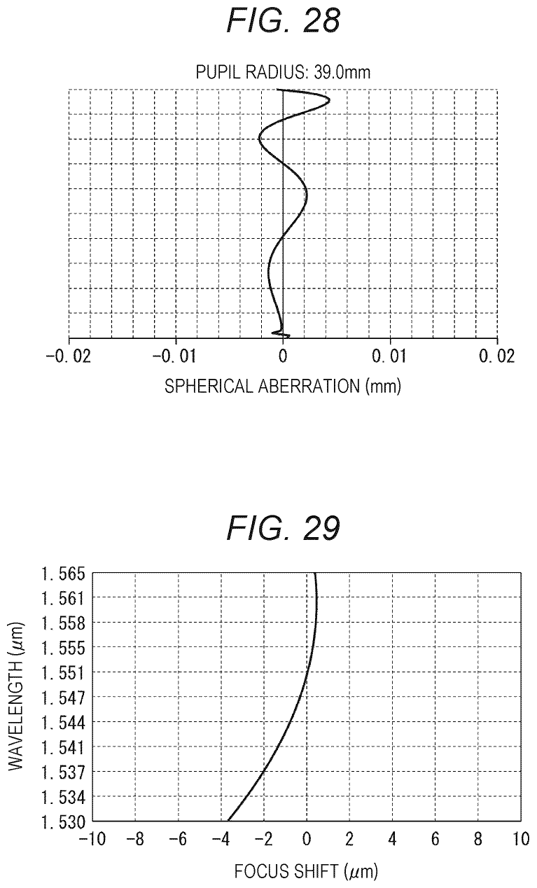

FIG. 27 is a front view schematically illustrating a configuration of an optical communication optical system of Example 8, FIG. 28 is a spherical aberration diagram of the optical system in which the wedge prism is removed from the optical communication optical system of Example 8 at a wavelength of 1550 nm, and FIG. 29 is a diagram illustrating wavelength dependency of a focus shift amount at a wavelength of 1530 nm to 1565 nm of the optical communication optical system of Example 8. Table 22 illustrates numerical data of the optical communication optical system, Table 23 illustrates numerical data of aspheric coefficients, and Table 24 illustrates rotation angles with respect to each apex angle for vibration isolation correction of the vibration angle of 100 mrad of the wedge prism and numerical data of Formula (2) at that time. In Table 22, surface numbers 1 to 10 represent a first group, surface numbers 11 to 15 represent a second group, surface numbers 16 to 23 represent a third group, and surface numbers 24 to 30 represent a fourth group. The first group and the second group in the optical communication optical system of Example 8 constitute a Galilean optical system.

TABLE 22

| Surface | | | | | | |
|---|---|---|---|---|---|---|
| number | Type | R | D | n1530 | n1550 | n1565 |
| 1 | STO | INF | 0 | | | |
| 2 | SPH | 147.178 | 18.476 | 1.501223 | 1.500992 | 1.500876 |
| 3 | SPH | −94.558 | 5.000 | 1.79930 | 1.79885 | 1.79863 |
| 4 | SPH | 418.410 | 10.000 | | | |
| 5 | SPH | 287.165 | 14.117 | 1.501223 | 1.500992 | 1.500876 |
| 6 | SPH | −124.493 | 10.000 | | | |
| 7 | SPH | INF | 14.993 | | | |
| 8 | SPH | −118.452 | 5.000 | 1.501223 | 1.500992 | 1.500876 |
| 9 | SPH | 78.912 | 14.283 | 1.76444 | 1.76413 | 1.76398 |
| 10 | SPH | −528.765 | 147.131 | | | |
| 11 | ASP | 526.806 | 5.000 | 1.501223 | 1.500992 | 1.500876 |
| 12 | ASP | 64.080 | 2.000 | | | |
| 13 | SPH | 39278.407 | 4.000 | 1.501223 | 1.500992 | 1.500876 |
| 14 | SPH | 17.844 | 100.000 | | | |
| 15 | SPH | INF | 5.000 | | | |
| 16 | SPH | INF | 5.000 | 1.44426 | 1.44402 | 1.44390 |
| 17 | SPH | INF | 5.000 | | | |
| 18 | SPH | INF | 5.000 | 1.44426 | 1.44402 | 1.44390 |
| 19 | SPH | INF | 5.000 | | | |
| 20 | SPH | INF | 5.000 | 1.44426 | 1.44402 | 1.44390 |
| 21 | SPH | INF | 5.000 | | | |
| 22 | SPH | INF | 5.000 | 1.44426 | 1.44402 | 1.44390 |
| 23 | SPH | INF | 50.000 | | | |
| 24 | SPH | −47.447 | 3.000 | 1.501223 | 1.500992 | 1.500876 |
| 25 | SPH | 13.378 | 2.000 | | | |
| 26 | SPH | 16.633 | 10.000 | 1.76444 | 1.76413 | 1.76398 |
| 27 | SPH | −17.660 | 5.000 | 1.501223 | 1.500992 | 1.500876 |
| 28 | SPH | 10.286 | 2.000 | | | |
| 29 | SPH | 15.534 | 10.000 | 1.76444 | 1.76413 | 1.76398 |
| 30 | ASP | −237.702 | 37.449 | | | |

TABLE 23

| Surface | | | | | |
|---|---|---|---|---|---|
| number | K | A4 | A6 | A8 | A10 |
| 11 | 0.000 | −1.772E−05 | −2.785E−07 | −1.460E−09 | −5.802E−11 |
| 12 | 0.000 | −1.968E−05 | −4.042E−07 | −6.430E−09 | −5.495E−11 |
| 30 | 0.000 | −2.117E−05 | −2.197E−07 | −1.837E−09 | 1.908E−11 |

TABLE 24

| Vertical angle (°) | Rotation angle (°) | Formula (2) |
|---|---|---|
| 2.17 | 13.988 | 6.446 |
| 4 | 7.522 | 1.881 |
| 6 | 4.990 | 0.832 |
| 8 | 3.723 | 0.465 |
| 10 | 2.959 | 0.296 |
| 12 | 2.446 | 0.204 |
| 14 | 2.077 | 0.148 |
| 16 | 1.798 | 0.112 |

### Example 9

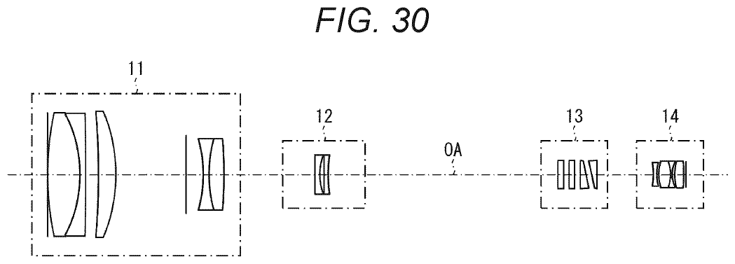

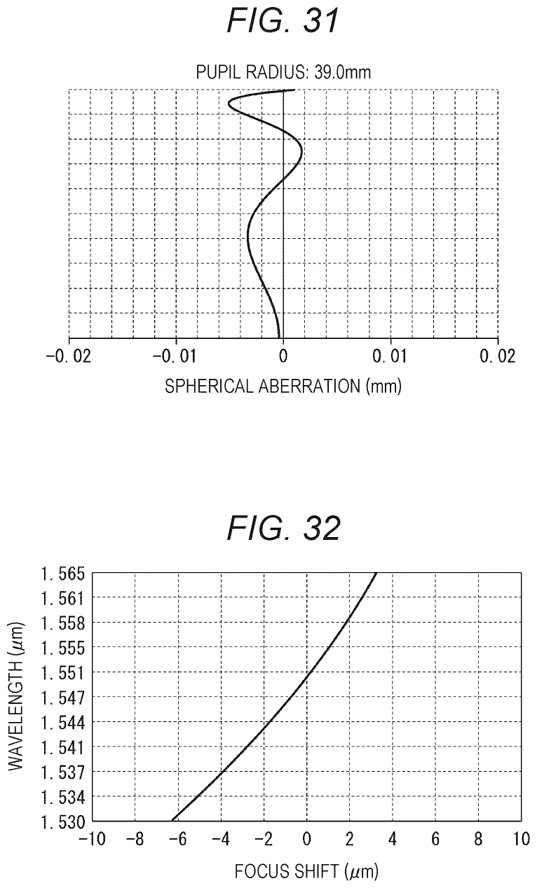

FIG. 30 is a front view schematically illustrating a configuration of an optical communication optical system of Example 9, FIG. 31 is a spherical aberration diagram of the optical system in which the wedge prism is removed from the optical communication optical system of Example 9 at a wavelength of 1550 nm, and FIG. 32 is a diagram illustrating wavelength dependency of the focus shift amount in the wavelength of 1530 nm to 1565 nm of the optical communication optical system of Example 9. Table 25 illustrates numerical data of the optical communication optical system, Table 26 illustrates numerical data of aspheric coefficients, and Table 27 illustrates rotation angles with respect to each apex angle for vibration isolation correction of the vibration angle of 100 mrad of the wedge prism and numerical data of Formula (2) at that time. In Table 25, surface numbers 1 to 10 represent a first group, surface numbers 11 to 15 represent a second group, surface numbers 16 to 23 represent a third group, and surface numbers 24 to 30 represent a fourth group. The first group and the second group in the optical communication optical system of Example 9 constitute a Galilean optical system.

TABLE 25

| Surface | | | | | | |
|---|---|---|---|---|---|---|
| number | Type | R | D | n1530 | n1550 | n1565 |
| 1 | STO | INF | 0 | | | |
| 2 | SPH | 131.982 | 29.000 | 1.501223 | 1.500992 | 1.500876 |
| 3 | SPH | −61.619 | 5.000 | 1.79930 | 1.79885 | 1.79863 |
| 4 | SPH | −1296.849 | 11.404 | | | |
| 5 | SPH | −349.081 | 15.605 | 1.50226 | 1.502368 | 1.502582 |
| 6 | SPH | −76.094 | 62.788 | | | |
| 7 | SPH | INF | 15.187 | | | |
| 8 | SPH | −57.588 | 5.000 | 1.501223 | 1.500992 | 1.500876 |
| 9 | SPH | 61.231 | 13.351 | 1.76444 | 1.76413 | 1.76398 |
| 10 | SPH | −178.373 | 81.187 | | | |
| 11 | ASP | INF | 4.219 | 1.499711 | 1.499831 | 1.50007 |
| 12 | ASP | 25.840 | 3.760 | | | |
| 13 | SPH | INF | 3.500 | 1.501223 | 1.500992 | 1.500876 |
| 14 | SPH | 51.680 | 200.000 | | | |
| 15 | SPH | INF | 5.000 | | | |
| 16 | SPH | INF | 5.000 | 1.44426 | 1.44402 | 1.44390 |
| 17 | SPH | INF | 5.000 | | | |
| 18 | SPH | INF | 5.000 | 1.44426 | 1.44402 | 1.44390 |
| 19 | SPH | INF | 5.000 | | | |
| 20 | SPH | INF | 5.000 | 1.44426 | 1.44402 | 1.44390 |
| 21 | SPH | INF | 5.000 | | | |
| 22 | SPH | INF | 5.000 | 1.44426 | 1.44402 | 1.44390 |
| 23 | SPH | INF | 50.000 | | | |
| 24 | SPH | −28.107 | 3.000 | 1.501223 | 1.500992 | 1.500876 |
| 25 | SPH | 19.812 | 2.000 | | | |
| 26 | SPH | 24.377 | 10.000 | 1.76444 | 1.76413 | 1.76398 |
| 27 | SPH | −19.730 | 2.000 | 1.501223 | 1.500992 | 1.500876 |
| 28 | SPH | 14.793 | 2.000 | | | |
| 29 | SPH | 20.610 | 8.000 | 1.76444 | 1.76413 | 1.76398 |
| 30 | ASP | −105.469 | 53.986 | | | |

TABLE 26

| Surface | | | | | |
|---|---|---|---|---|---|
| number | K | A4 | A6 | A8 | A10 |
| 30 | 0.000 | −2.037E−06 | −3.416E−08 | −4.865E−11 | −1.207E−12 |

TABLE 27

| Vertical angle (°) | Rotation angle (°) | Formula (2) |
|---|---|---|
| 2 | 12.630 | 6.315 |
| 4 | 6.262 | 1.566 |
| 6 | 4.155 | 0.693 |
| 8 | 3.100 | 0.388 |
| 10 | 2.464 | 0.246 |
| 12 | 2.083 | 0.174 |
| 14 | 1.730 | 0.124 |
| 16 | 1.497 | 0.094 |

### Example 10

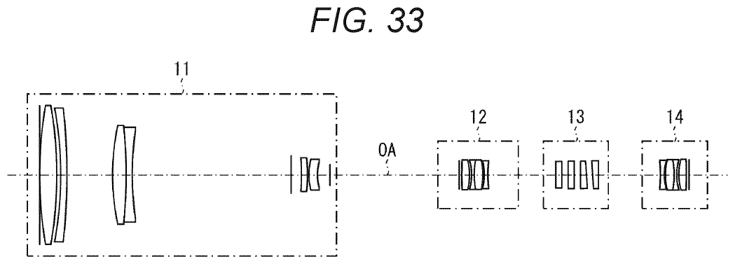

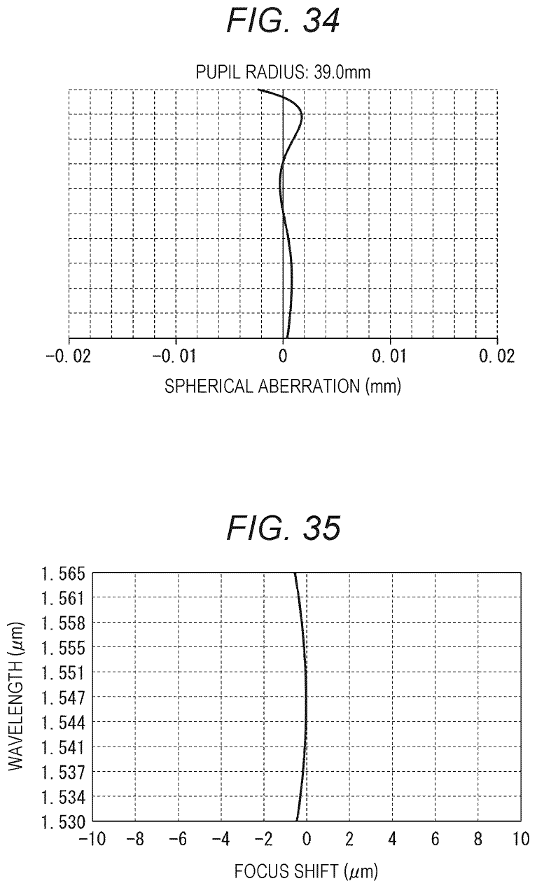

FIG. 33 is a front view schematically illustrating a configuration of an optical communication optical system of Example 10, FIG. 34 is a spherical aberration diagram of an optical system of Example 10 excluding a wedge prism at a wavelength of 1550 nm, and FIG. 35 is a diagram illustrating wavelength dependency of a focus shift amount at a wavelength of 1530 nm to 1565 nm of the optical communication optical system of Example 10. Table 28 illustrates numerical data of the optical communication optical system, Table 29 illustrates numerical data of aspheric coefficients, and Table 30 illustrates rotation angles with respect to each apex angle for vibration isolation correction of the vibration angle of 100 mrad of the wedge prism and numerical data of Formula (2) at that time. In Table 28, surface numbers 1 to 13 represent a first group, surface numbers 14 to 21 represent a second group, surface numbers 22 to 29 represent a third group, and surface numbers 30 to 36 represent a fourth group. The first group and the second group in the optical communication optical system of Example 10 constitute a Keplerian optical system.

TABLE 28

| Surface | | | | | | |
|---|---|---|---|---|---|---|
| number | Type | R | D | n1530 | n1550 | n1565 |
| 1 | STO | INF | 0 | | | |
| 2 | SPH | 161.898 | 14.000 | 1.60019 | 1.59993 | 1.59980 |
| 3 | SPH | −161.898 | 3.000 | | | |
| 4 | SPH | −149.438 | 5.032 | 1.79930 | 1.79885 | 1.79863 |
| 5 | SPH | −247.836 | 37.000 | | | |
| 6 | SPH | 90.591 | 11.000 | 1.50122 | 1.50099 | 1.50088 |
| 7 | SPH | −200.913 | 5.000 | 1.91169 | 1.91103 | 1.91070 |
| 8 | SPH | 120.161 | 129.031 | | | |
| 9 | SPH | INF | 8.035 | | | |
| 10 | SPH | −216.546 | 5.000 | 1.50122 | 1.50099 | 1.50088 |
| 11 | SPH | −61.786 | 1.133 | | | |
| 12 | SPH | 26.886 | 7.000 | 1.799296 | 1.798853 | 1.798632 |
| 13 | SPH | 18.887 | 54.770 | | | |
| 14 | SPH | INF | 62.269 | | | |
| 15 | ASP | 119.990 | 6.000 | 1.76444 | 1.76413 | 1.76398 |
| 16 | SPH | −25.540 | 2.000 | | | |
| 17 | SPH | −19.168 | 2.000 | 1.50122 | 1.50099 | 1.50088 |
| 18 | SPH | 34.660 | 7.000 | 1.76444 | 1.76413 | 1.76398 |
| 19 | SPH | −25.540 | 1.000 | | | |
| 20 | SPH | −23.952 | 3.000 | 1.50122 | 1.50099 | 1.50088 |
| 21 | SPH | 36.979 | 50.000 | | | |
| 22 | SPH | INF | 5.000 | 1.44426 | 1.44402 | 1.44390 |
| 23 | SPH | INF | 5.000 | | | |
| 24 | SPH | INF | 5.000 | 1.44426 | 1.44402 | 1.44390 |
| 25 | SPH | INF | 5.000 | | | |
| 26 | SPH | INF | 5.000 | 1.44426 | 1.44402 | 1.44390 |
| 27 | SPH | INF | 5.000 | | | |
| 28 | SPH | INF | 5.000 | 1.44426 | 1.44402 | 1.44390 |
| 29 | SPH | INF | 50.000 | | | |
| 30 | SPH | −36.979 | 3.000 | 1.50122 | 1.50099 | 1.50088 |
| 31 | SPH | 23.952 | 1.000 | | | |
| 32 | SPH | 25.540 | 7.000 | 1.76444 | 1.76413 | 1.76398 |
| 33 | SPH | −34.660 | 2.000 | 1.50122 | 1.50099 | 1.50088 |
| 34 | SPH | 19.168 | 2.000 | | | |
| 35 | SPH | 25.540 | 6.000 | 1.76444 | 1.76413 | 1.76398 |
| 36 | ASP | −119.990 | 62.269 | | | |

TABLE 29

| Surface | | | | | |
|---|---|---|---|---|---|
| number | K | A4 | A6 | A8 | A10 |
| 15 | 0.000 | −1.203E−06 | 7.056E−09 | 4.578E−12 | 7.763E−14 |
| 36 | 0.000 | 1.203E−06 | −7.056E−09 | −4.578E−12 | −7.763E−14 |

TABLE 30

| Vertical angle (°) | Rotation angle (°) | Formula (2) |
|---|---|---|
| 2 | 10.099 | 5.050 |
| 4 | 5.019 | 1.255 |
| 6 | 3.333 | 0.556 |
| 8 | 2.487 | 0.311 |
| 10 | 1.977 | 0.198 |
| 12 | 1.634 | 0.136 |
| 14 | 1.388 | 0.099 |

### Example 11

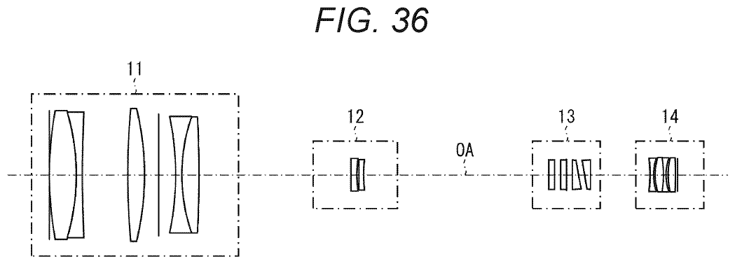

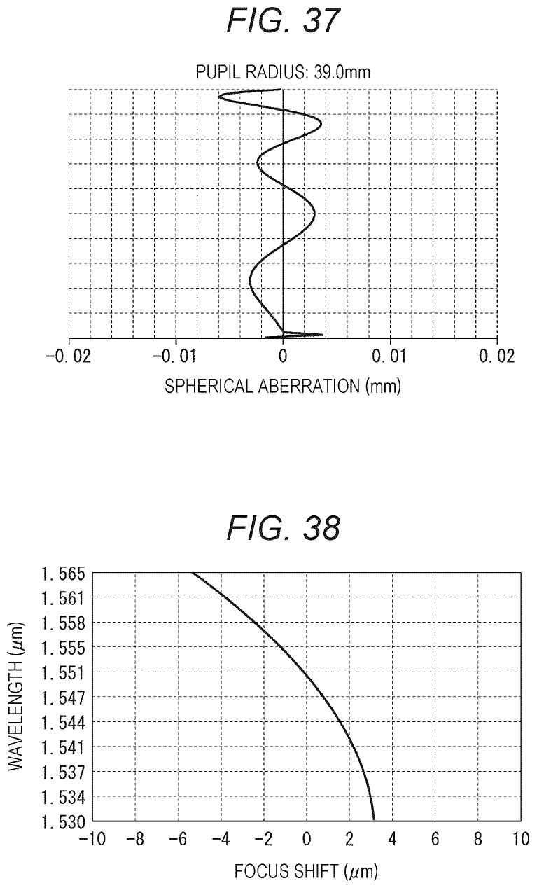

FIG. 36 is a front view schematically illustrating a configuration of an optical communication optical system of Example 11, FIG. 37 is a spherical aberration diagram of an optical system of Example 11 excluding a wedge prism at a wavelength of 1550 nm, and FIG. 38 is a diagram illustrating wavelength dependency of a focus shift amount at a wavelength of 1530 nm to 1565 nm of the optical communication optical system of Example 11. Table 31 illustrates numerical data of the optical communication optical system, Table 32 illustrates numerical data of aspheric coefficients, and Table 33 illustrates rotation angles with respect to each apex angle for vibration isolation correction of the vibration angle of 100 mrad of the wedge prism and numerical data of Formula (2) at that time. In Table 31, surface numbers 1 to 10 represent a first group, surface numbers 11 to 15 represent a second group, surface numbers 16 to 23 represent a third group, and surface numbers 24 to 30 represent a fourth group. The first group and the second group in the optical communication optical system of Example 11 constitute a Galilean optical system.

TABLE 31

| Surface | | | | | | |
|---|---|---|---|---|---|---|
| number | Type | R | D | n1530 | n1550 | n1565 |
| 1 | SPH | INF | 0 | | | |
| 2 | SPH | 161.254 | 22.474 | 1.501223 | 1.500992 | 1.500876 |
| 3 | SPH | −98.686 | 5.000 | 1.79930 | 1.79885 | 1.79863 |
| 4 | SPH | 590.632 | 38.130 | | | |
| 5 | SPH | 345.321 | 13.981 | 1.501223 | 1.500992 | 1.500876 |
| 6 | SPH | −127.326 | 11.959 | | | |
| 7 | SPH | INF | 14.281 | | | |
| 8 | SPH | −119.969 | 5.001 | 1.501223 | 1.500992 | 1.500876 |
| 9 | SPH | 79.969 | 14.324 | 1.76444 | 1.76413 | 1.76398 |
| 10 | SPH | −574.073 | 127.323 | | | |
| 11 | ASP | 142.686 | 5.000 | 1.501223 | 1.500992 | 1.500876 |
| 12 | ASP | 34.521 | 1.744 | | | |
| 13 | ASP | INF | 4.000 | 1.501223 | 1.500992 | 1.500876 |
| 14 | ASP | 56.203 | 150.000 | | | |
| 15 | SPH | INF | 5.000 | | | |
| 16 | SPH | INF | 5.000 | 1.44426 | 1.44402 | 1.44390 |
| 17 | SPH | INF | 5.000 | | | |
| 18 | SPH | INF | 5.000 | 1.44426 | 1.44402 | 1.44390 |
| 19 | SPH | INF | 5.000 | | | |
| 20 | SPH | INF | 5.000 | 1.44426 | 1.44402 | 1.44390 |
| 21 | SPH | INF | 5.000 | | | |
| 22 | SPH | INF | 5.000 | 1.44426 | 1.44402 | 1.44390 |
| 23 | SPH | INF | 50.000 | | | |
| 24 | SPH | −60.861 | 3.000 | 1.501223 | 1.500992 | 1.500876 |
| 25 | SPH | 24.956 | 1.138 | | | |
| 26 | SPH | 26.402 | 7.000 | 1.76444 | 1.76413 | 1.76398 |
| 27 | SPH | −53.543 | 2.000 | 1.501223 | 1.500992 | 1.500876 |
| 28 | SPH | 21.347 | 2.000 | | | |
| 29 | SPH | 28.335 | 6.000 | 1.76444 | 1.76413 | 1.76398 |
| 30 | ASP | −267.951 | 71.253 | | | |

TABLE 32

| Surface | | | | | |
|---|---|---|---|---|---|
| number | K | A4 | A6 | A8 | A10 |
| 11 | 0.000 | −1.840E−05 | −1.722E−07 | −3.579E−10 | −4.350E−13 |
| 12 | 0.000 | −1.529E−05 | −3.232E−07 | −2.590E−09 | 1.380E−11 |
| 13 | 0.000 | 3.162E−07 | −5.549E−09 | −1.721E−10 | 2.517E−13 |
| 14 | 0.000 | −3.698E−06 | 8.973E−08 | 1.537E−09 | −9.308E−12 |
| 30 | 0.000 | 5.954E−07 | −3.323E−09 | −4.219E−12 | 8.334E−15 |

TABLE 33

| Vertical angle (°) | Rotation angle (°) | Formula (2) |
|---|---|---|
| 2 | 8.402 | 4.201 |
| 4 | 4.181 | 1.045 |
| 6 | 2.777 | 0.463 |
| 8 | 2.072 | 0.259 |
| 10 | 1.647 | 0.165 |
| 12 | 1.362 | 0.114 |
| 13.44 | 1.210 | 0.090 |

### Example 12

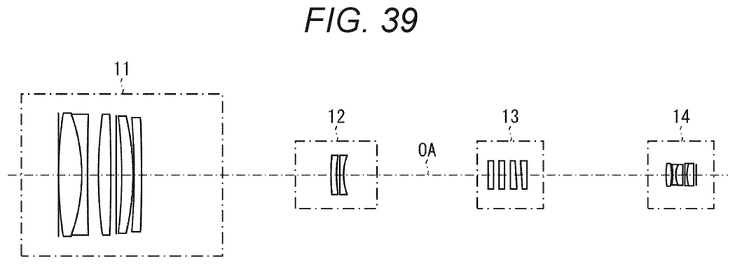

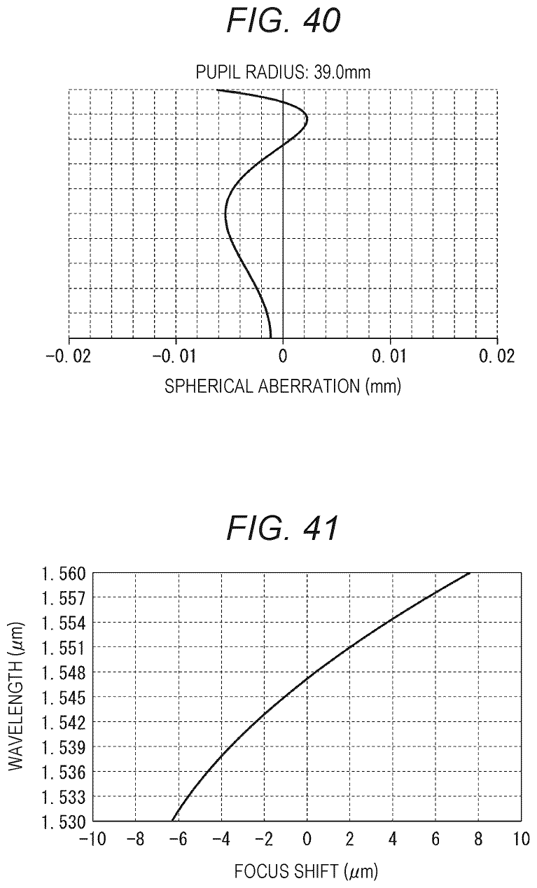

FIG. 39 is a front view schematically illustrating a configuration of an optical communication optical system of Example 12, FIG. 40 is a spherical aberration diagram of an optical system of Example 12 excluding a wedge prism at a wavelength of 1550 nm, and FIG. 41 is a diagram illustrating wavelength dependency of a focus shift amount at a wavelength of 1530 nm to 1565 nm of the optical communication optical system of Example 12. Table 34 illustrates numerical data of the optical communication optical system, and Table 35 illustrates a rotation angle with respect to each apex angle for correcting vibration isolation of the vibration angle of 100 mrad of the wedge prism and numerical data of Formula (2) at that time. In Table 34, surface numbers 1 to 10 represent a first group, surface numbers 11 to 15 represent a second group, surface numbers 16 to 23 represent a third group, and surface numbers 24 to 31 represent a fourth group. The first group and the second group in the optical communication optical system of Example 12 constitute a Galilean optical system.

TABLE 34

| Surface | | | | | | |
|---|---|---|---|---|---|---|
| number | Type | R | D | n1530 | n1550 | n1565 |
| 1 | SPH | INF | 0 | | | |
| 2 | SPH | 183.986 | 21.000 | 1.60019 | 1.59993 | 1.59980 |
| 3 | SPH | −82.488 | 5.032 | 1.79930 | 1.79885 | 1.79863 |
| 4 | SPH | 850.996 | 10.000 | | | |
| 5 | SPH | 208.976 | 10.959 | 1.50258 | 1.50237 | 1.50226 |
| 6 | SPH | −762.299 | 5.000 | | | |
| 7 | SPH | INF | 5.000 | | | |
| 8 | SPH | −219.133 | 10.000 | 1.50122 | 1.50099 | 1.50088 |
| 9 | SPH | −117.612 | 1.000 | | | |
| 10 | SPH | −325.572 | 7.000 | 1.76336 | 1.76301 | 1.76284 |
| 11 | SPH | −508.598 | 170.126 | | | |
| 12 | SPH | 100.000 | 5.000 | 1.50258 | 1.50237 | 1.50226 |
| 13 | SPH | 62.026 | 2.899 | | | |
| 14 | SPH | INF | 3.500 | 1.50122 | 1.50099 | 1.50088 |
| 15 | SPH | 25.840 | 125.000 | | | |
| 16 | SPH | INF | 5.000 | 1.44426 | 1.44402 | 1.44390 |
| 17 | SPH | INF | 5.000 | | | |
| 18 | SPH | INF | 5.000 | 1.44426 | 1.44402 | 1.44390 |
| 19 | SPH | INF | 5.000 | | | |
| 20 | SPH | INF | 5.000 | 1.44426 | 1.44402 | 1.44390 |
| 21 | SPH | INF | 5.000 | | | |
| 22 | SPH | INF | 5.000 | 1.44426 | 1.44402 | 1.44390 |
| 23 | SPH | INE | 125.000 | | | |
| 24 | SPH | 37.302 | 5.000 | 1.50122 | 1.50099 | 1.50088 |
| 25 | SPH | −24.491 | 0.999 | | | |
| 26 | SPH | −28.633 | 3.000 | 1.76113 | 1.76070 | 1.76049 |
| 27 | SPH | 12.710 | 6.000 | 1.50122 | 1.50099 | 1.50088 |
| 28 | SPH | 241.751 | 2.000 | | | |
| 29 | SPH | 116.415 | 2.000 | 1.50122 | 1.50099 | 1.50088 |
| 30 | SPH | 17.456 | 6.000 | 1.87300 | 1.87315 | 1.87296 |
| 31 | SPH | −150.303 | 50.709 | | | |

TABLE 35

| Vertical angle (°) | Rotation angle (°) | Formula (2) |
|---|---|---|
| 2 | 10.962 | 5.481 |
| 4 | 5.445 | 1.361 |
| 6 | 3.615 | 0.603 |
| 8 | 2.698 | 0.337 |
| 10 | 2.145 | 0.215 |
| 12 | 1.773 | 0.148 |
| 14 | 1.506 | 0.108 |
| 15.2 | 1.378 | 0.091 |

The numerical values obtained from the above-described Formulae (1), (3), and (4) in Examples 1 to 12 are illustrated in Tables 36 and 37.

TABLE 36

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Ff/Bf | 6.567 | 6.494 | 6.567 | 6.494 | 3.896 | 12.994 |
| \|C1 − C2\| | 6.830 | 1.346 | 6.841 | 1.342 | 0.000 | 14.715 |
| n | 1.44402 | 1.44402 | 1.673623 | 1.42843 | 1.44402 | 1.44402 |

TABLE 37

| | Exam- | Exam- | Exam- | Exam- | Exam- | Exam- |
|---|---|---|---|---|---|---|
| | ple 7 | ple 8 | ple 9 | ple 10 | ple 11 | ple 12 |
| Ff/Bf | 9.740 | 7.778 | 6.476 | 5.194 | 4.335 | 5.632 |
| \|C1 − C2\| | 0.369 | 4.062 | 9.521 | 0.097 | 8.469 | 13.879 |
| n | 1.44402 | 1.44402 | 1.44402 | 1.44402 | 1.44402 | 1.44402 |

What is claimed is:

1. An optical communication optical system disposed on an optical path of signal light emitted from a light emitting element and transmitted or signal light incident on a light receiving element and received, the optical communication optical system comprising:
a first group, a second group, a third group, and a fourth group arranged in this order from a side opposite to the light emitting element or the light receiving element,
wherein the first group changes a beam diameter of the signal light so as to be smaller at an end on the second group side in an optical axis direction,
wherein the second group changes a beam diameter of the signal light so as to be smaller at an end on the third group side in the optical axis direction,
wherein the third group includes two wedge prism pairs, and the wedge prism pairs include two wedge prisms that rotate in opposite directions and at the same rotation angle,
wherein the fourth group changes a beam diameter of the signal so as to be smaller at an end on the light emitting element side or the light receiving element side in the optical axis direction, and
wherein Formulae (1) and (2) below are satisfied:
$$3.89 < Ff / Bf < 14. \qquad ( 1 )$$
$$0.09 < R / a < 6.565 \qquad ( 2 )$$
(in Formula (1), Ff represents a focal length (mm) of the first group and Bf represents a focal length (mm) of the second group, and in Formula (2), R represents a rotation angle of the wedge prism in one or the other wedge prism pair and a represents an apex angle of the wedge prism in one or the other wedge prism pair).

2. The optical communication optical system according to claim 1,
wherein Formula (3) is satisfied:
$$\vert C 1 - C 2 \vert \leq 14.715 \qquad ( 3 )$$
(in Formula (3), C1 represents a movement amount (μm) of a focal position of the signal light having a wavelength of 1530 nm with reference to a focal position of the signal light having a wavelength of 1550 nm, and C2 represents a movement amount (μm) of a focal position of the signal light having a wavelength of 1565 nm with reference to a focal position of the signal light having a wavelength of 1550 nm).

3. The optical communication optical system according to claim 1,
wherein Formula (4) is satisfied:
$$< Formula ( 4 ) >$$
$$1.4 < n < 1.674 \qquad ( 4 )$$
(In Formula (4), n represents a refractive index of light having a wavelength of 1550 nm in a material of the wedge prism).

4. The optical communication optical system according to claim 1,
wherein the second group and the fourth group change a beam diameter of the signal light so that the signal light between both groups becomes collimated light.

5. The optical communication optical system according to claim 1,
wherein at least any one of the first group, the second group, and the fourth group includes an aspherical lens.

6. An optical communication apparatus comprising:
the optical communication optical system according to claim 1.
